(19) United States
(12) Patent Application Publication
(10) Pub. No.: US 2025/0364550 A1
(43) Pub. Date: Nov. 27, 2025

(54) METHOD AND SYSTEM FOR GRAPHENE ENCAPSULATED CATHODE MATERIALS WITH REDUCED TRANSITION METAL DISSOLUTION

(71) Applicant: California Institute of Technology, Pasadena, CA (US)

(72) Inventors: David A. Boyd, La Canada, CA (US); Brent T. Fultz, Pasadena, CA (US); William C. West, South Pasadena, CA (US); Cullen M. Quine, Pasadena, CA (US); Channing C. Ahn, Pasadena, CA (US); Jasmina Pasalic, Pasadena, CA (US)

(73) Assignee: California Institute of Technology, Pasadena, CA (US)

(21) Appl. No.: 18/884,900

(22) Filed: Sep. 13, 2024

Related U.S. Application Data
(60) Provisional application No. 63/651,835, filed on May 24, 2024.

(51) Int. Cl. H01M 4/525; H01M 4/36; H01M 10/0525

(52) U.S. Cl. CPC H01M 4/525; H01M 4/366; H01M 10/0525

(57) ABSTRACT

A battery cell includes an electrolyte, an anode, and a cathode. The cathode comprises a plurality of cathode active material units at least partially coated with graphene encapsulated nanoparticles, carbon, and binders. Each of the graphene encapsulated nanoparticles comprises a nanoparticle encapsulated in one or more graphene layers, an outermost of the one or more graphene layers having extended graphene sections. The one or more graphene layers or the extended graphene sections comprise one or more functional groups including hydrogen, oxygen, or nitrogen.

### CROSS-REFERENCES TO RELATED APPLICATIONS

This application claims benefit under 35 USC § 119(e) to U.S. Provisional Patent Application No. 63/651,835 filed May 24, 2024, entitled “Composite Coated Cathode Active Material, Lithium Battery Including the Same, and Preparation Method Thereof,” the disclosure of which is hereby incorporated by reference in its entirety.

### STATEMENT AS TO RIGHTS TO INVENTIONS MADE UNDER FEDERALLY SPONSORED RESEARCH AND DEVELOPMENT

This invention was made with government support under Grant No. 80NMO0018D0004 awarded by NASA. The government has certain rights in the invention.

### BACKGROUND OF THE INVENTION

Mn-rich cathode active materials (CAM) for lithium ion batteries (LIB) are desirable from a capacity-cost standpoint, but their performance is limited by transition metal dissolution (TMD).

Despite the progress made in the area of LIB, there is a need in the art for improved methods and systems related to suppression of TMD in LIB.

### SUMMARY OF THE INVENTION

Embodiments of the present invention relate to methods and systems for the suppression of TMD in LIB. More particularly, embodiments of the present invention provide methods and systems for forming particulate coatings including functionalized graphene encapsulated nanoparticles on CAM. In a specific embodiment, a plasma enhanced chemical vapor deposition system is utilized to fabricate functionalized graphene encapsulated nanoparticles including functional groups, the chemical and electrochemical properties of which, suppress TMD. The present invention is applicable to a variety of battery systems.

According to embodiments of the present invention, functionalized graphene encapsulated nanoparticles (FGEN), prepared by microwave plasma-enhanced chemical vapor deposition (MW-PECVD), were dry coated onto particles of active cathode materials of LiNi_{0.8}Mn_{0.1}Co_{0.1}O₂ (NMC811) and Li_{1.2}Ni_{0.13}Mn_{0.54}Co_{0.13}O₂ (LNMC). With the addition of 1 wt. % FGEN to the CAM, cells of both LNMC and NMC811 showed improved rate capability and capacity retention under all test conditions. Dry coatings of FGEN suppress TMD in LNMC and improve performance, even under stressful conditions of elevated temperature, high voltage and extended cycling. Within FGEN, there is a distribution of the microstructure between nanocarbon and extended graphene, and this has proven to be useful for coating CAM particles of differing size. For example, in cases in which LNMC particles were not coated with extended graphene, the nanocarbon was effective in suppressing TMD while improving the charge-rate capacity, by up to 42% and doubling the lifetimes. FGEN dry coatings offer performance improvements and can be applied with a scalable, industrial process. Defects and functional groups present in the FGEN play a role in suppressing TMD. The ability of dry coatings to suppress TMD in Mn-rich CAMs may provide a path to an alternative CAM with less cobalt.

Numerous benefits are achieved by way of the present invention over conventional techniques. For example, embodiments of the present invention provide for scalable, material-independent, dry coating methods useful during CAM fabrication. Dry coating the Mn-rich CAM surfaces with functionalized graphene encapsulated nanoparticles (e.g., 1 wt %) has resulted in the suppression of TMD while nearly doubling the cycle life and improving rate capacities up to 42% under stressful conditions. These and other embodiments of the invention, along with many of its advantages and features, are described in more detail in conjunction with the text below and attached figures.

### BRIEF DESCRIPTION OF THE DRAWINGS

FIG. 1A is a simplified schematic diagram illustrating a lithium-ion battery cell according to an embodiment of the present invention.

FIG. 1B is a simplified schematic diagram of a cathode for a lithium-ion battery cell according to an embodiment of the present invention.

FIG. 2 is a simplified schematic diagram of a plasma enhanced chemical vapor deposition suitable for fabrication of functionalized graphene encapsulated nanoparticles according to an embodiment of the present invention.

FIG. 3A is a simplified schematic diagram of cathode active material coated with functionalized graphene encapsulated nanoparticles according to an embodiment of the present invention.

FIG. 3B is a plot showing results of a Raman mapping cluster analysis for NCM811 cathode active material coated with functionalized graphene encapsulated nanoparticles according to an embodiment of the present invention.

FIG. 3C is a plot showing results of a Raman mapping cluster analysis for LNMC cathode active material coated with functionalized graphene encapsulated nanoparticles according to an embodiment of the present invention.

FIG. 4A is a simplified schematic diagram illustrating formation of a functionalized graphene encapsulated nanoparticle according to an embodiment of the present invention.

FIG. 4B is a transmission electron microscope image of nanoparticles.

FIG. 4C is a transmission electron microscope image of nanoparticles coated with nanocarbon according to an embodiment of the present invention.

FIG. 4D is a transmission electron microscope image of layered graphene deposited on nanoparticles according to an embodiment of the present invention.

FIG. 4E is a transmission electron microscope image of nanoparticles coated with nanocarbon and extended, functionalized graphene according to an embodiment of the present invention.

FIG. 4F is a plot showing an X-ray diffraction analysis of silicon oxide nanoparticles and functionalized graphene encapsulated nanoparticles according to an embodiment of the present invention.

FIG. 4G is an X-ray photoelectron spectroscopy spectrum for silicon oxide nanoparticles and functionalized graphene encapsulated nanoparticles according to an embodiment of the present invention.

FIG. 4H is an X-ray photoelectron spectroscopy (XPS) spectrum for functionalized graphene encapsulated nanoparticles according to an embodiment of the present invention.

FIG. 4I is an X-ray photoelectron spectroscopy spectrum for the Si 2p region of functionalized graphene encapsulated nanoparticles according to an embodiment of the present invention.

FIG. 4J is an X-ray photoelectron spectroscopy spectrum for the O 1s region of functionalized graphene encapsulated nanoparticles according to an embodiment of the present invention.

FIG. 4K is an illustration of a partial structure of graphene functionalized with hydroxyl groups, i.e., hydroxyl moieties. The wavy lines in the illustration indicate that additional structure of the graphene beyond the wavy lines is not shown.

FIG. 4L is an illustration of a partial structure of graphene functionalized with epoxide groups.

FIG. 4M is an illustration of a partial structure of graphene functionalized with carboxylic acid groups

FIG. 4N is an illustration of a partial structure of graphene functionalized with ketone groups, i.e., oxo groups.

FIG. 4O is an illustration of a partial structure of graphene functionalized with quaternary amine structures, pyridine structures, and pyrrole structures.

FIGS. 5A-5B are plots showing the discharge specific capacities of NMC811 CAM and NMC811 CAM coated with FGEN at 25° C. and 60° C., respectively.

FIGS. 5C-5D are plots showing the discharge specific capacities of LNMC CAM and LNMC CAM coated with FGEN at 25° C. and 60° C., respectively.

FIGS. 5E-5F are plots showing the cycling performance of NMC811 CAM, LNMC CAM, NMC811 CAM coated with FGEN, and LNMC CAM coated with FGEN at 25° C. and 60° C., respectively.

FIGS. 6A-6F are plots showing the concentrations of Mn, Ni, and Co in the lithium anodes of LNMC cells with and without FGEN coatings after cycling according to an embodiment of the present invention.

FIG. 7A is an X-ray photoelectron spectroscopy spectrum for LNMC and LNMC-FGEN cathodes that underwent extended cycling at 4.60 V charge cutoff, 60° C. according to an embodiment of the present invention.

FIG. 7B is a magnified region of the XRD spectrum shown in FIG. 7A according to an embodiment of the present invention.

FIG. 8A is a plot showing partial gas pressures in the plasma enhanced chemical vapor deposition chamber during growth according to an embodiment of the present invention.

FIG. 8B is a plot showing partial pressures of select reactants and products during growth according to an embodiment of the present invention.

FIG. 8C is a plot of excess carbon as a function of growth time according to an embodiment of the present invention.

FIG. 8D is a plot of reflected microwave power and microwave frequency during growth according to an embodiment of the present invention.

FIG. 9 is a simplified flowchart illustrating a method of fabricating functionalized graphene encapsulated nanoparticles according to an embodiment of the present invention.

### DETAILED DESCRIPTION OF SPECIFIC EMBODIMENTS

Embodiments of the present invention relate to methods and systems for the suppression of TMD in LIB. More particularly, embodiments of the present invention provide methods and systems for forming particulate coatings including functionalized graphene encapsulated nanoparticles on CAM. In a specific embodiment, a plasma enhanced chemical vapor deposition system is utilized to fabricate graphene encapsulated nanoparticles including functional groups, the chemical and electrochemical properties on which suppress TMD. The present invention is applicable to a variety of battery systems.

As described more fully herein, embodiments of the present invention provide a LIB incorporating a CAM with a dry coating that suppresses TMD. This dry coating can include guest particles containing carbon with defects and or functional groups. As an example, the LIB can include CAM incorporating a nanoparticle of an oxide material (e.g., SiO₂) containing functional groups, for instance a LIB with CAM incorporating nanoparticle carbon, e.g. carbon black that has been functionalized, with the functional groups including carbon, hydrogen, hydrocarbon functional groups, nitrogen, oxygen, fluorine, sulfur, and/or phosphorous. The structures can contain hydrogen functional groups including alkanes, alkynes, aromatic hydrocarbons, and/or alkanes. The structures can contain nitrogen functional groups including amines, aziridines, azides, anilines, pyrroles, amides, imines, and/or nitriles. The structures can contain oxygen functional groups including hydroxyls, carbonyls, ethers, esters, carboxyls, acetyls, and/or hydroperoxyls. The carbon coating can be an allotrope of carbon including graphene, carbon nano tubes, graphite, diamond, glassy carbon, diamond-like carbon, or the like. The coating can be a composite of functionalized carbon and a nanoparticle in which the functionalized carbon encapsulates the nanoparticle. In other embodiments, the LIB can include a CAM incorporating a direct coating of functionalized carbon onto the cathode without composite particles.

The nanoparticle can be an oxide of silicon, tin, magnesium, manganese, or the like. The nanoparticle can be a polymer. The nanoparticle can be a fluoropolymer. The nanoparticle can be a sulfonated polymer. The carbon coating can include graphene that is functionalized with hydrogen, nitrogen, oxygen, sulfur, and/or fluorine groups. The carbon coating can include graphene that is produced by chemical vapor deposition, for example, plasma enhanced chemical vapor deposition, microwave plasma enhanced chemical vapor deposition, or microwave plasma chemical vapor deposition. The dry-coating can include guest particles of carbon that possess defects. The defects can be edges, Stone-Wales defects, single vacancies, multiple vacancies, carbon adatoms, foreign adatoms, and/or substitutional impurities. The coating can be applied to the CAM at 0.001 to 10.0 weight percent.

Merely by way of example, an embodiment of the present invention is Li_{1.2}Ni_{0.13}Mn_{0.54}Co_{0.13}O₂ (LNMC) with a dry-coating of functionalized graphene encapsulated nanoparticles (FGEN), with the nanoparticle being SiO₂ (e.g., with a diameter of 10-20 nm). As discussed more fully below, the inventors have demonstrated the comparative effects of FGEN coatings on the rate capability and cycle life of LNMC. The FGEN coatings improve the rate capability and the cycle life compared to uncoated LNMC. Also, the inventors have demonstrated the comparative effects of FGEN coatings on TMD suppression in LNMC. The FGEN coatings effectively suppress the TMD compared to uncoated LNMC.

Thus, some embodiments of the present invention provide dry coatings that enable an atomically continuous barrier against incursion of HF or dissolution of Mn²⁺. In other embodiments, the dry coatings do not form an atomically continuous barrier. The dry coating including guest particles containing carbon with defects and/or functional groups described herein act as a chemical barrier, not just a physical barrier, to suppress or prevent TMD. The functional groups and/or defects can act as charge donors, chelating agents, and coordination complexes, to effectively trap Mn²⁺ ions as well as other transition metals that may be included in the CAM while also improving rate capability. The functional groups and/or defects can also act to prevent the disproportionation reaction of Mn³⁺ in the CAM. Similarly, oxygen containing functional groups in the coating can neutralize HF present. The density of the guest particles is such that is smaller than the diffusion length of the Mn²⁺ ion.

Lithium-ion batteries (LIB) have widespread applications in portable electronics and electric vehicles (EVs) owing to their high specific energy (120-270 Whr/kg) and high energy density (300-750 Wh/l). Their continued success is placing increasing demands on further improvements in performance and cost. Shorter charging times and lower cost of ownership are essential for EV adoption and improvements in cathode technology can help address both of these challenges. The rate capability of a cell, inversely related to its charging time, is fundamentally determined by the ionic and electronic transport properties of the cathode at normal operating temperatures.

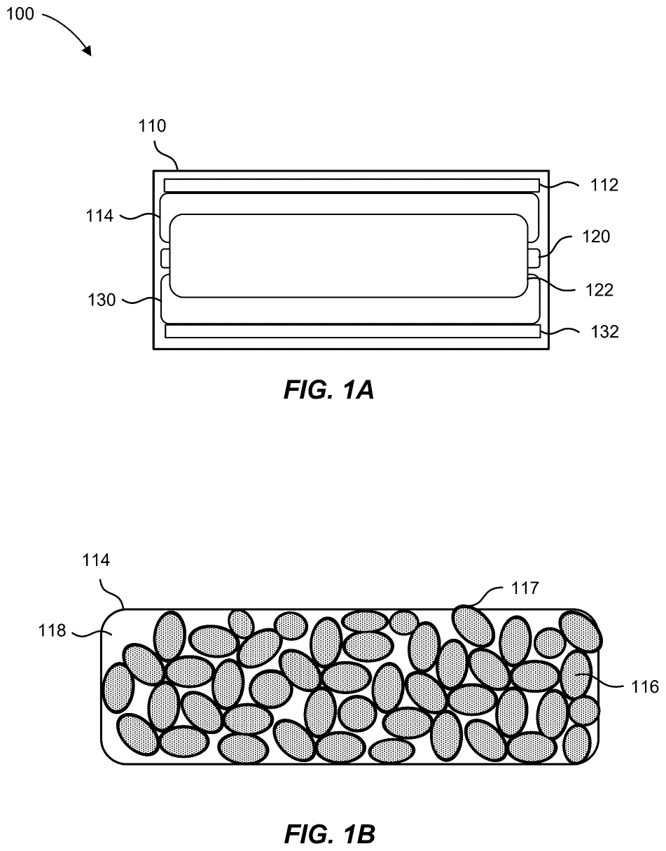

FIG. 1A is a simplified schematic diagram illustrating a lithium-ion battery cell according to an embodiment of the present invention. As illustrated in FIG. 1A, the lithium-ion battery cell 100 includes a battery cell case 110 enclosing a cathode 114 and an anode 130. Additional discussion related to the cathode 114 is provided in relation to FIG. 1B. The battery cell case 110 also encloses a cathode current collector 112, a separator 120, liquid electrolyte 122 that infiltrates the cathode 114, the anode 130, the separator 120, and an anode current collector 132.

FIG. 1B is a simplified schematic diagram of a cathode for a lithium-ion battery cell according to an embodiment of the present invention. The cathode 114 includes a binder 118 with conductive carbon that binds together CAM units 116 coated with functionalized graphene encapsulated nanoparticles 117.

Thus, the cathode 114 is illustrated in FIG. 1B in an assembled state that is an agglomerate of particulate CAM units 116, the binder 118, and conductive agents, forming a network with interfaces at the liquid electrolyte and at the solid electrode. These interfaces can affect the lithium ion diffusion, the electronic conductivity, and charge transfer. Stabilizing the interfaces at the CAM can lead to increased rate capabilities and longer cycle life. Cathodes are the primary cost drivers in LIB and improvements that increase cell lifetimes could reduce the cost of EV ownership. However, advances in cathode performance have come, in part, at the expense of limited mineral resources. For example, the constituent components of state-of-the-art (SOA) layered oxides such as NMC, are lithium, manganese, nickel, and cobalt. Cobalt, most notably, is not only scarce, it is also subject to the uncertainties of supply chains and the economics, ethics, and politics of mining and ore processing, making the need for lower cost alternatives self-evident. A challenge for LIB cathodes is to do more with less: increase rate capability and cycle life while using less high-value materials.

Although capacity values for SOA cathodes are approaching 200 mAh/g and 500+ cycles, under moderate conditions, performance can be fleeting since the CAM can suffer performance loss for a variety of reasons including deleterious side interactions with the electrolyte, mechanical stresses during charge and discharge, phase transformations, Jahn-Teller distortion (JTD), and TMD. TMD is an unwanted effect that occurs when transition metals in the CAM are dissolved and typically reduced at the anode upon cycling, and it is generally associated with degradation of the solid electrolyte interphase (SEI). Not only does TMD affect the cathode crystallographic phase, but the dissolution of Mn ions can destabilize the electrolyte and the SEI and degrade the graphite anode. This limits the use of Mn-rich CAM such as LiMn₂O₄ (LMO) and Li_{1.2}Ni_{0.13}Mn_{0.54}Co_{0.13}O₂ (LNMC), which are desirable because they use relatively less Ni and Co compared to SOA NMC, e.g., LiNi_{0.8}Mn_{0.1}Co_{0.1}O₂ (NMC811).

As described herein, embodiments of the present invention apply coatings to the CAM using a dry coating process, also referred to as mechanofusion, dry particle fusion, high-intensity mixing, or ordered mixing. Dry coating avoids the need for solvents, high temperature, and vacuum, making it amenable to a variety of coatings and CAM. It is also a scalable, top-down process that has been used in industrial applications including pharmaceuticals, toners, lubricants, and cosmetics in which previously formed “guest particles” are attached to relatively much larger “host particles” using mechanical forces.

Herein, the performance of NMC811 and LNMC (half-cells) with and without coatings of FGEN is analyzed. The FGEN comprise silica nanoparticles (e.g., 10-20 nm in diameter) coated with graphene produced by microwave plasma-enhanced chemical vapor deposition (MW-PECVD) in a fluidized bed reactor (FBR). MW-PECVD, in contrast with thermal CVD, is capable of producing high quality graphene at lower temperatures and introducing the functional groups that enable the suppression of TMD. NMC811 is also a Ni-rich CAM, and cells with FGEN dry coatings (NMC811-FGEN) showed relative improvements in rate capability at 25° C. and 60° C. compared to NMC811. The LNMC cells with FGEN dry coatings (LNMC-FGEN) demonstrated improvements in both cycle life and rate capability. Inductively-Coupled Mass Spectrometry (ICP-MS) was used to measure the transition metals deposited on the lithium foil anodes of LNMC cells that were cycled to upper cut-off voltages (UCV) of 4.30, 4.45, and 4.60 V, at 60° C. The inventors determined that the dry coatings of FGEN suppressed the concentration of Mn, Ni, and Co dissolved from the cathode and subsequently reduced at the anode at all UCV, thereby conclusively demonstrating that CAM with dry coatings of FGEN can suppress TMD.

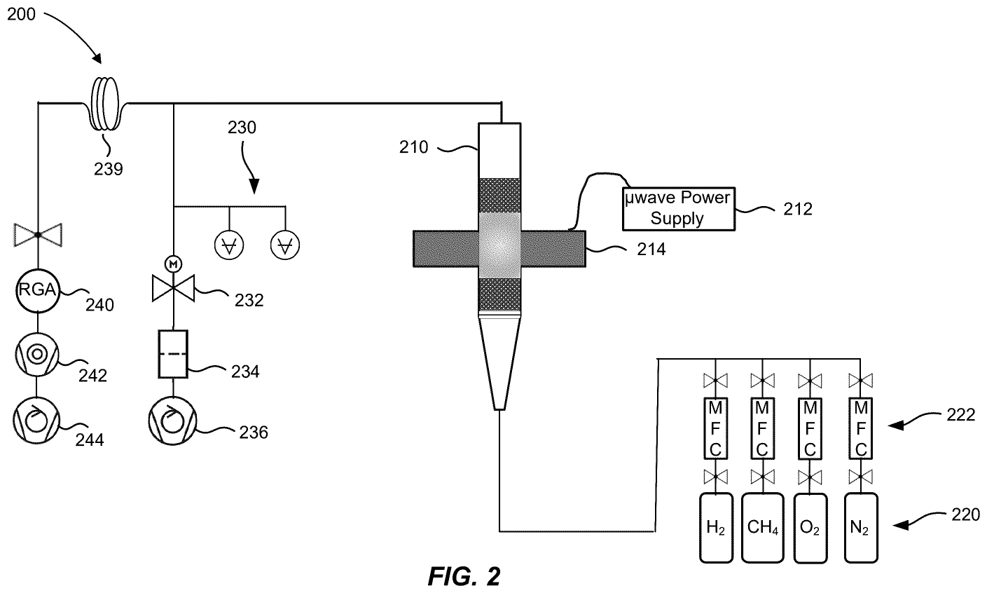

FIG. 2 is a simplified schematic diagram of a plasma enhanced chemical vapor deposition (PECVD) system 200 suitable for fabrication of functionalized graphene encapsulated nanoparticles according to an embodiment of the present invention. The system can be referred to as a quartz FBR.

Referring to FIG. 2, the substrate materials are placed in quartz FBR 210 and microwave power supply 212 is utilized to energize microwave cavity 214. Process gasses are provided using gas sources 220 with flow rates of the various process gasses controlled using corresponding mass flow controllers 222. In the illustrated embodiment, gas sources 220 were hydrogen, methane, oxygen, and nitrogen, although other gas sources can be utilized.

A reduced pressure atmosphere in the reactor 210 was achieved using turbo pump 242 and vacuum pump 244 and vacuum pump 236. Pressure gauges 230, pressure control valve 232, and trap 234 are utilized in conjunction with the illustrated pumps. Reactants and products were measured using residual gas analyzer (RGA) 240 in fluid communication with reactor 210 through capillary tube 239.

PECVD FGEN were prepared by microwave PECVD in a quartz FBR 210. Silica nanopowder (10-20 nm), purity 99.5% on trace metals analysis (Sigma-Aldrich, 637238) was used as the starting material. The nanopowder was placed in the quartz FBR 210 and baked at reduced pressure (500 mTorr) under flowing Ar at 125° C. for two hours to remove moisture prior to PECVD growth. The PECVD process gasses were H₂ and CH₄, and the process pressure was 750 mTorr. The gas flows were controlled at a ratio of H₂:CH₄ (5:1.2) and the magnitude of the flows depended on the degree of fluidization required and were typically on the order 1-10 sccm. The microwave power used during PECVD growth was 100 W. The growth time depended on the amount of silica in the tube and would typically be a few hours for several hundred milligrams of material. Pristine SiO₂ is snow white, and the PECVD process was stopped in some embodiments when the powder became uniformly black. In other embodiments, endpoint detection was utilized as described more fully herein. Separate batches of FGEN were created for NMC811 and LNMC, and the carbon content, as measured by TGA, was 11% and 17%, respectively.

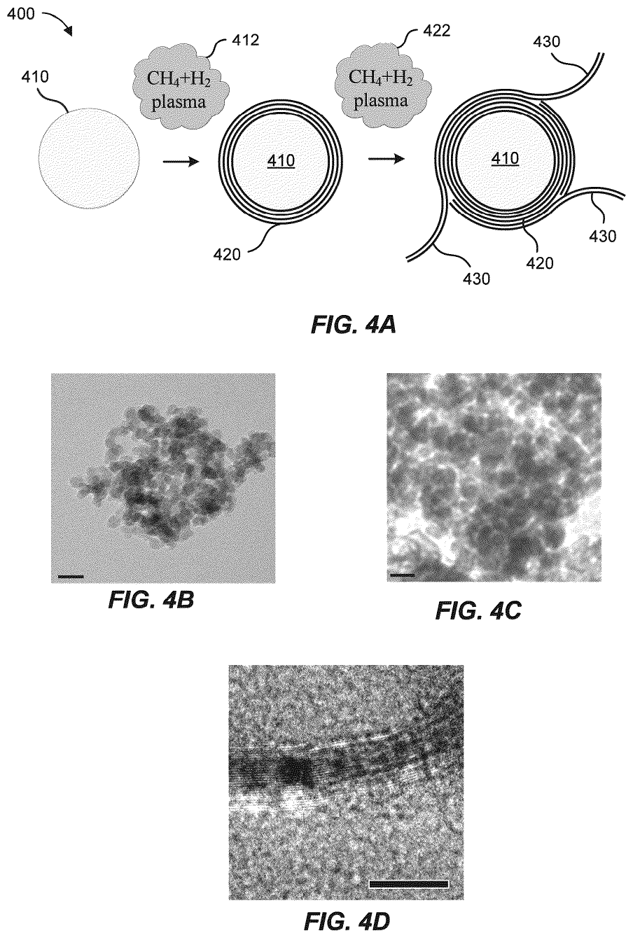

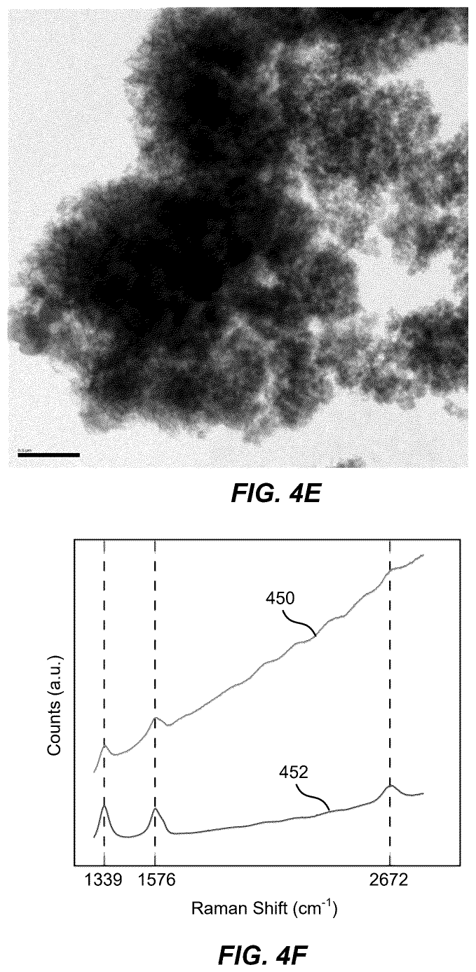

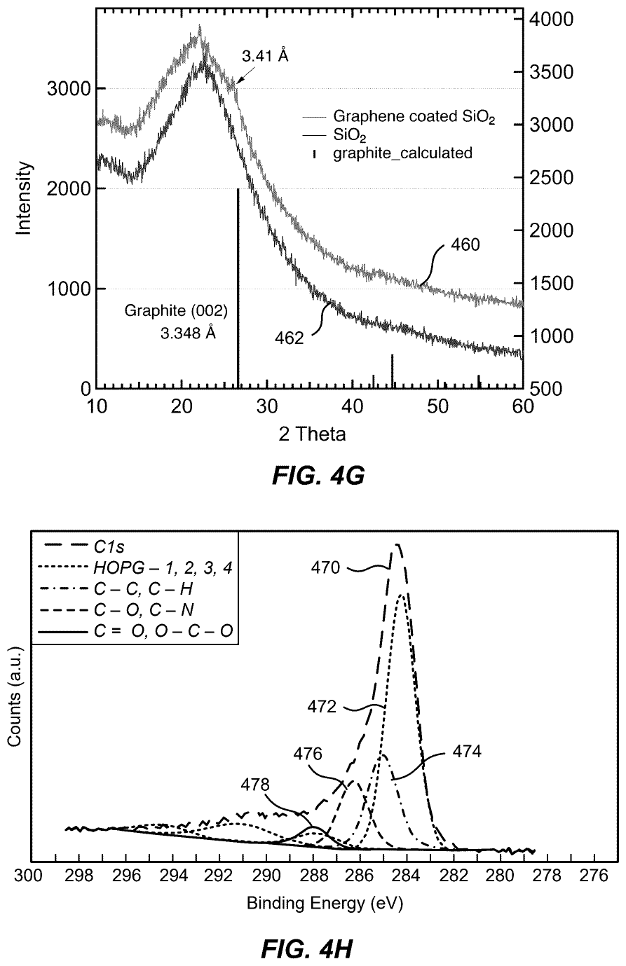

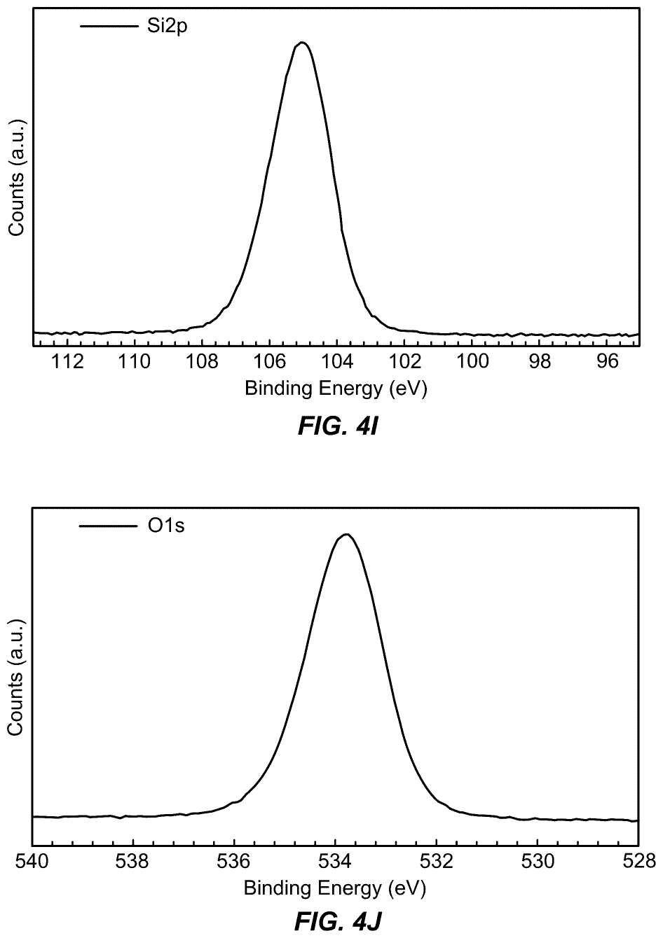

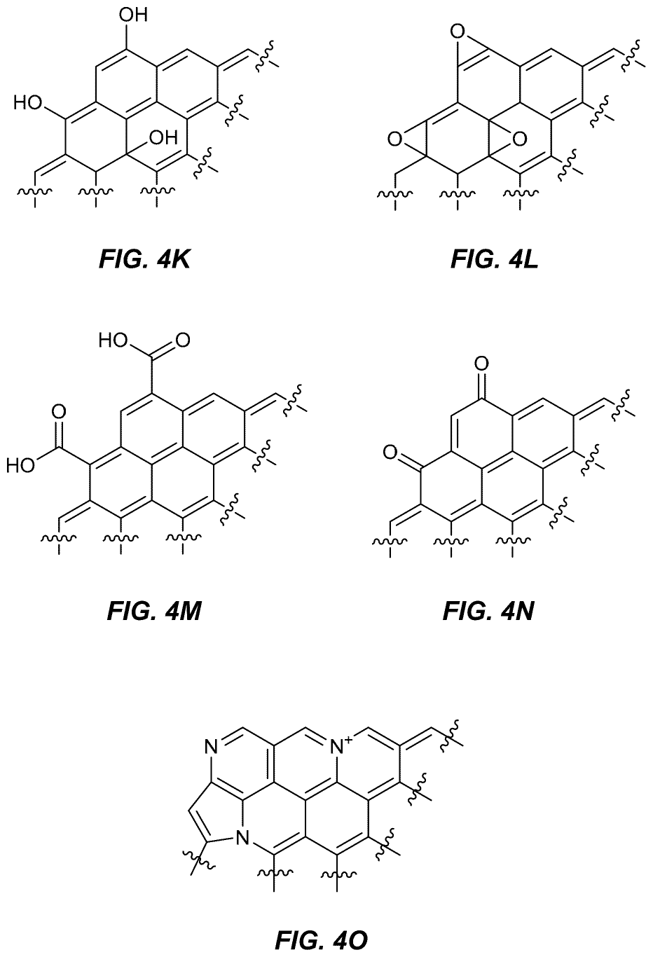

The inventors have determined that uncoated silica material is difficult to handle under vacuum conditions. Using conventional processes in which the pump down is performed quickly with no gas flow in order to improve efficiency, the nanopowder would agglomerate into clumps. These clumps proved to be unsatisfactory as deposition substrates and were difficult to divide into smaller particles. Therefore, in order to prevent powder agglomeration, embodiments of the present invention utilize a pump down procedure in which the pump down was performed slowly in the presence of flowing gas. This process prevented nanopowder agglomeration and facilitated graphene deposition on the separated nanoparticles as discussed more fully in relation to FIG. 4A. Additionally, the inventors have determined that in conventional systems, the force of plasma pushes the powder out of the plasma zone, making it difficult to coat. Accordingly, embodiments of the present invention can utilize a quartz paddle that holds the powder in place so the powder can be coated. The plasma is generally most intense on the outer wall of the reactor tube and, therefore, only coats this immediate region. As such, the powder generally needs to be stirred and a paddle can be utilized accordingly. However, the inventors have determined that the paddle also allows for the powder to move up and down in the reaction tube, which was an unexpected result. Thus, embodiments of the present invention enable the ability to hold the powder in place and to manipulate the powder during coating.

The inventors have determined that the PECVD system 200 illustrated in FIG. 2 and utilized to fabricate the structures described herein provides improved tap density of the nanopowder in comparison to conventional systems. As an example, the volume of the coated powder can be less than half of the volume of the uncoated powder. Higher tap densities are desirable for batteries since the higher tap density can translate to higher volumetric energy densities. Thus, embodiments of the present invention provide much higher tap densities, e.g., twice the tap density, than that achieved using thermal CVD processes. Thus, embodiments of the present invention are well suited for battery applications in comparison to structures fabricated using conventional processes such as thermal CVD, which are characterized by low tap densities rendering them undesirable for many applications.

Using the microwave PECVD system illustrated in FIG. 2, FGEN were prepared. In some embodiments, the process involved exposing silica nanopowder (e.g., 10-20 nm in diameter) to a cold plasma of H₂ and CH₄. The microwave PECVD process is notably different than thermal CVD. Thermal CVD of graphene occurs by the catalytic dehydrogenation of methane on the substrate. It is an atmospheric, high temperature process, e.g., 1000° C., and being catalytic, the growth is self-limited once the substrate is covered with carbon. In the case of graphene balls, catalysis is a result of reducing the underlying SiO₂ nanoparticles.

In contrast, PECVD growth occurs by active species generated in a low-pressure plasma. It is catalyst-free and growth is not limited by access to the substrate, which can allow for extended multilayer graphene sheets to form. The methane-hydrogen plasma is a rich chemical environment that can simultaneously support a variety of active species. Carbon deposition is predominantly by methyl radicals, and atomic hydrogen can etch amorphous carbon, resulting in formation of highly crystalline carbon. Atmospheric species can also be present in the plasma e.g. ozone and atomic oxygen, which, for example, can allow for the inclusion of oxygen functional groups. The growth temperature can also be much lower, e.g., 425° C., which can allow functional groups to remain in the graphene. Although some embodiments utilized atmospheric gasses, other embodiments can utilize sources of the various functional groups discussed herein, including sources of fluorine, sulfur, and/or phosphorous of the like.

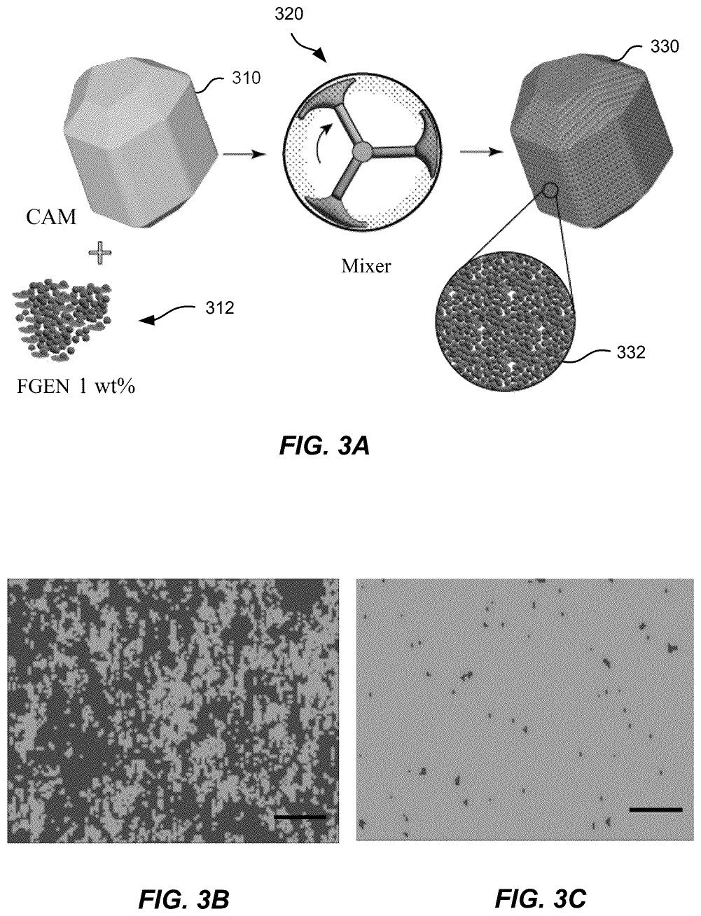

FIG. 3A is a simplified schematic diagram of cathode active material coated with functionalized graphene encapsulated nanoparticles according to an embodiment of the present invention. In the embodiment illustrated in FIG. 3A, a CAM unit 310 is combined with FGEN 312 at 1 wt % in a mixer 320 and mixed for a predetermined period of time and predetermined rotation speed, generally measured in revolutions per minute (RPM). In practice, numerous CAM units are combined with numerous FGEN. One of ordinary skill in the art would recognize many variations, modifications, and alternatives. After the mixing process, a CAM unit at least partially covered with FGEN 330 is produced. As shown in the magnified image 332, the CAM unit 310 is not fully covered or coated in some embodiments, but in other embodiments, the CAM unit is fully encapsulated by the FGEN.

Dry coating can be affected by a number of factors including the relative sizes of the host and guest particles and bulk density of the host powder, and the optimal run time and blade speed for each CAM were determined empirically. Raman mapping cluster analysis (RMCA) was employed to assess the distribution of extended graphene (XG) and nanocarbon (NC) within the FGEN and the dry-coated CAM. FIGS. 3B and 3C demonstrate the microstructure and coverage of FGEN dry coatings on different CAMs.

FIG. 3B is a plot showing results of a Raman mapping cluster analysis for NCM811 cathode active material coated with functionalized graphene encapsulated nanoparticles according to an embodiment of the present invention. As shown in FIGS. 3B and 3C, RMCA show a difference in the relative amounts of XG and NC before and after dry coating. The ratio of XG:NC in the FGEN used with NMC811 was found to be 93:7, but upon dry coating onto the NCM811, the ratio was 50:50 as shown in FIG. 3B.

FIG. 3C is a plot showing results of an RMCA for LNMC cathode active material coated with functionalized graphene encapsulated nanoparticles according to an embodiment of the present invention. The ratio of XG:NC in the FGEN used with LNMC was 79:21, but upon dry coating onto the LNMC, the ratio was 1:99 as shown in FIG. 3C.

This disparity in the ratios of XG:NC in the NMC811-FGEN and LNMC-FGEN can by understood by comparing the microstructure of the FGEN with that of the CAMs. Dry coating is inherently affected by the relative sizes of the guest and host particles, and it is assumed that the guest particles are at least 10 times smaller than the host particles. From the discussion above, we see that the FGEN is a mixture of XG and NC structures, which have very different sizes. The FGEN-NC structures have characteristic sizes of 38 nm and the FGEN-XG can extend up to hundreds of nanometers. In comparison, the average particle size of the NCM811 is D₅₀=9˜15 μm. This range of values is supported by SEM images of pristine NMC811 powder shown in FIG. 4B, which shows that the nanoparticles comprise mainly secondary particles on order of 10 μm in diameter. These particles are much larger than either the FGEN-NC or the FGEN-XG, and, as such, both the FGEN-NC and FGEN-XG should be able to effectively dry-coat the NMC811.

However the microstructure of LNMC is much different. SEM images of the LNMC-FGEN after dry coating show that the LNMC consists mainly of primary particles with an average diameter of 200 nm. This size is on the order of the FGEN-XG, and, as such, it would not be expected that the FGEN-XG would effectively coat the LNMC. On the other hand, the primary particle size of the LNMC is 5× larger than the FGEN-NC. Although this size difference is not considered ideal, it is sufficient to allow the FGEN-NC to coat the LNMC host. These results highlight the importance of understanding the relative microstructure for dry coating.

FIG. 4A is a simplified schematic diagram illustrating formation of a functionalized graphene encapsulated nanoparticle according to an embodiment of the present invention. Referring to FIG. 4A, the FGEN PECVD process 400 is shown schematically, starting with a nanoparticle 410 of SiO₂, which is exposed to a cold plasma of CH₄ and H₂ 412 forming one or more layers of nanocarbon (NC) 420. In the schematic diagram shown in FIG. 4A, multiple layers of NC 420 are illustrated, which is also shown in FIG. 4D. With continued exposure to the plasma 422, extended graphene (XG) 430 forms.

The PECVD conditions for FGEN are similar to those of vertical graphene (VG), which uses relatively higher flows of CH₄ than for planar graphene. VG growth is a single-step process that occurs in two stages. As illustrated in FIG. 4A, the first stage is the formation of a basal (buffer) layer including one or more layers of NC 420 on the nanoparticle 410 acting as a substrate. The one or more layers of NC 420 is typically either nanographitic or amorphous carbon in nature with a thickness on the order of 10-20 nm.

The second stage is the emergence of XG 430 from the base layer. The inventors believe, without limiting embodiments of the present invention, that the growth of XG 430 occurs as a result of a planar mismatch of adjoining graphite layers and from areas of high curvature. In the case of FGEN, the nanoparticle 410 is first coated with the one or more layers of NC 420, e.g., one or more layers of crystalline carbon, and the inherent high curvature of the nanoparticle 410, e.g., a silica nanoparticle in the nanopowder including numerous nanoparticles, and the associated high film stress, promotes the emergence of XG 430.

The inventors have determined that the PECVD process utilized in the embodiments described herein operates using different physical phenomena and produces notably different graphene structures than that achieved using thermal CVD growth processes, for example, graphene balls consisting of graphene encapsulated silica nanoparticles produced by a high temperature thermal CVD process. Thermal CVD of graphene occurs by the catalytic dehydrogenation of methane on the substrate. The reaction for this thermal process can be described as follows: at this temperature, CH₄ is decomposed to generate hydrogen atoms, which can subsequently reduce SiO₂ to SiOₓ (x<2). OH⁻ is also simultaneously produced via the following reaction: SiO₂+CH₄→SiOₓ+OH⁻+3H⁺+carbon(graphene).

Thus, in this reaction, the produced SiOₓ provides catalytic sites for graphene growth, and OH⁻ serves as a mild oxidant to facilitate the graphitic carbon formation toward graphene. Accordingly, in thermal CVD processes, the growth of graphene balls is an atmospheric, high temperature process, e.g., 1000° C., and being catalytic, the growth is self-limited, i.e., stops, once the substrate is covered with carbon. This limits the extent to which the graphene can grow and also limits the species that can be present in the graphene. In the above reaction, OH⁻+3H⁺ can only form from catalysis with SiO₂ nanoparticles. The high temperature also prevents oxygen and hydrogen functional groups from being incorporated into the graphene. Moreover, annealing graphene at high temperatures is used to remove defects in the graphene.

In contrast, the PECVD growth processes for FGEN utilized in embodiments of the present invention occurs by active species generated in a low-pressure plasma. This process is catalyst-free and growth is not limited by access to the substrate. Thus, embodiments enable extended, multilayer graphene sheets to form. The methane-hydrogen plasma is a rich chemical environment that can simultaneously support a variety of active species. Carbon deposition is predominantly by methyl radicals, CH₃⁺, and atomic hydrogen, H⁺, can etch amorphous carbon, resulting in formation of highly crystalline carbon. Atmospheric species or other species introduced using a source can also be present in the plasma e.g., ozone and atomic oxygen, which, for example can allow for the inclusion of oxygen functional groups into the graphene. The growth temperature can also be much lower, e.g. 425° C., which can allow functional groups to remain in the graphene.

The PECVD growth conditions for FGEN are similar to those of vertical graphene (VG), which uses relatively higher flows of CH₄ than for planar graphene. VG growth is a single-step process that occurs in two stages. The first stage is the formation of a basal (buffer) layer on the substrate. This layer is typically either nanographitic or amorphous carbon in nature with a thickness of 10-20 nm. The second stage is the emergence of VG from the base layer. The inventors believe, without limiting embodiments of the present invention, that this occurs as a result of a planar mismatch of adjoining graphite layers and from areas of high curvature. In the case of FGEN, the particles are first coated with a layer of crystalline carbon and the inherent high curvature of the silica nanoparticles, which are associated with high film stress, presumably promotes the emergence of VG.

Thus, because of the self-limiting growth that occurs during thermal CVD growth of graphene balls, the extent of the sheets is ˜50 nm. In contrast, the extent of the graphene sheets corresponding to FGEN provided by embodiments of the present invention is on the order of hundreds of nanometers.

The ability of FGEN dry coatings to suppress TMD during cycling is consistent with reports of carbon films derived from bottom-up methods. TMD occurs primarily during cycling of LIB when Mn⁺ ions disassociate from the lattice region of the CAM near the surface and dissolve into the electrolyte. The inventors believe that TMD occurs at the bottom of discharge when the concentration of M³⁺ is at the highest level and undergoes the following disproportionation reaction:

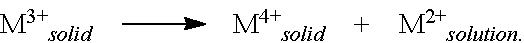

Once free from the lattice the Mn²⁺ ions can enter into the electrolyte and can eventually deposit on the anode, reducing performance. TMD not only degrades the CAM but can adversely affect the electrolyte and anode as well. TMD is a complicated process involving Jahn-Teller distortion (JTD) and surface reconstruction, as well as corrosion by acid (HF) generated by side-reactions in the electrolyte.

Suppression of TMD during cycling by a dry coating is remarkable, especially at elevated temperatures and over a range of UCV.

Dry-coated films do not necessarily need to form a continuous, physical barrier that could prevent TM ions from dissolving into the electrolyte and HF from directly contacting the CAM. However, the graphene in the FGEN coatings does contain functional groups and defects as evidenced by Raman spectroscopy and XPS, and these could play a role in suppressing TMD.

In certain embodiments, the functional groups and/or defects of the graphene in the provided FGEN coatings include or consist of one or more types of oxygen-containing functional groups. The oxygen-containing functional groups can, for example, include or consist of functional groups with carbon-oxygen single bonds, e.g., hydroxyl moieties (FIG. 4K), epoxide moieties (FIG. 4L), or a combination thereof. Additionally or alternatively, the oxygen-containing functional groups can include or consist of functional groups with carbon-oxygen double bonds, e.g., carboxylic acid moieties (FIG. 4M), ketone moieties (FIG. 4N), or a combination thereof. Oxygen-containing functional groups can be located in the interior of a graphene plane (FIGS. 4L and 4M) and/or on a graphene outer edge and/or rim surrounding an interior vacancy (FIGS. 4M-4N).

In some embodiments the graphene of the provided FGEN coating includes a total relative amount (e.g., as determined with an XPS C 1s spectra) of oxygen-containing bonds that is between about 10% and about 30%, e.g., between about 10% and about 26%, between about 10% and about 22%, between about 10% and about 18%, between about 10% and about 14%, between about 14% and about 30%, between about 14% and about 26%, between about 14% and about 22%, between about 14% and about 18%, between about 18% and about 30%, between about 18% and about 26%, between about 18% and about 22%, between about 22% and about 30%, between about 22% and about 26%, or between about 26% and about 30%. In terms of upper limits, the total relative amount of oxygen-containing bonds can be, for example, no more than about 30%, e.g., no more than about 28%, no more than about 26%, no more than about 24%, no more than about 22%, no more than about 20%, no more than about 18%, no more than about 16%, no more than about 14%, or no more than about 12%. In terms of lower limits, the total relative amount of oxygen-containing bonds can be, for example, no less than about 10%, e.g., no less than about 12%, no less than about 14%, no less than about 16%, no less than about 18%, no less than about 20%, no less than about 22%, no less than about 24%, no less than about 26%, or no less than about 28%. Higher relative amounts, e.g., no less than about 30%, and lower relative amounts, e.g., no more than about 10%, are also contemplated.

In some embodiments the graphene of the provided FGEN coating includes a total relative amount (e.g., as determined with an XPS C 1s spectra) of C—O bonds (e.g., bonds of hydroxyl moieties) that is between about 8% and about 20%, e.g., between about 8% and about 17.6%, between about 8% and about 15.2%, between about 8% and about 12.8%, between about 8% and about 10.4%, between about 10.4% and about 20%, between about 10.4% and about 17.6%, between about 10.4% and about 15.2%, between about 10.4% and about 12.8%, between about 12.8% and about 20%, between about 12.8% and about 17.6%, between about 12.8% and about 15.2%, between about 15.2% and about 20%, between about 15.2% and about 17.6%, or between about 17.6% and about 20%. In terms of upper limits, the total relative amount of C—O bonds can be, for example, no more than about 20%, e.g., no more than about 18.8%, no more than about 17.6%, no more than about 16.4%, no more than about 15.2%, no more than about 14%, no more than about 12.8%, no more than about 11.6%, no more than about 10.4%, or no more than about 9.2%. In terms of lower limits, the total relative amount of C—O bonds can be, for example, no less than about 8%, e.g., no less than about 9.2%, no less than about 10.4%, no less than about 11.6%, no less than about 12.8%, no less than about 14%, no less than about 15.2%, no less than about 16.4%, no less than about 17.6%, or no less than about 18.8%. Higher relative amounts, e.g., no less than about 20%, and lower relative amounts, e.g., no more than about 8%, are also contemplated.

In some embodiments the graphene of the provided FGEN coating includes a total relative amount (e.g., as determined with an XPS C 1s spectra) of C═O bonds (e.g., bonds of ketone moieties) and/or O—C—O bonds (e.g., bonds of epoxide moieties) that is between about 2% and about 5%, e.g., between about 2% and about 4.4%, between about 2% and about 3.8%, between about 2% and about 3.2%, between about 2% and about 2.6%, between about 2.6% and about 5%, between about 2.6% and about 4.4%, between about 2.6% and about 3.8%, between about 2.6% and about 3.2%, between about 3.2% and about 5%, between about 3.2% and about 4.4%, between about 3.2% and about 3.8%, between about 3.8% and about 5%, between about 3.8% and about 4.4%, or between about 4.4% and about 5%. In terms of upper limits, the total relative amount of C—O bonds and/or O—C—O bonds can be, for example, no more than about 5%, e.g., no more than about 4.7%, no more than about 4.4%, no more than about 4.1%, no more than about 3.8%, no more than about 3.5%, no more than about 3.2%, no more than about 2.9%, no more than about 2.6%, or no more than about 2.3%. In terms of lower limits, the total relative amount of C—O bonds and/or O—C—O bonds can be, for example, no less than about 2%, e.g., no less than about 2.3%, no less than about 2.6%, no less than about 2.9%, no less than about 3.2%, no less than about 3.5%, no less than about 3.8%, no less than about 4.1%, no less than about 4.4%, or no less than about 4.7%. Higher relative amounts, e.g., no less than about 5%, and lower relative amounts, e.g., no more than about 2%, are also contemplated.

In some embodiments the graphene of the provided FGEN coating includes a total relative amount (e.g., as determined with an XPS C 1s spectra) of O—C═O bonds (e.g., bonds of carboxylate moieties) that is between about 1% and about 3%, e.g., between about 1% and about 2.6%, between about 1% and about 2.2%, between about 1% and about 1.8%, between about 1% and about 1.4%, between about 1.4% and about 3%, between about 1.4% and about 2.6%, between about 1.4% and about 2.2%, between about 1.4% and about 1.8%, between about 1.8% and about 3%, between about 1.8% and about 2.6%, between about 1.8% and about 2.2%, between about 2.2% and about 3%, between about 2.2% and about 2.6%, or between about 2.6% and about 3%. In terms of upper limits, the total relative amount of O—C═O bonds can be, for example, no more than about 3%, e.g., no more than about 2.8%, no more than about 2.6%, no more than about 2.4%, no more than about 2.2%, no more than about 2%, no more than about 1.8%, no more than about 1.6%, no more than about 1.4%, or no more than about 1.2%. In terms of lower limits, the total relative amount of O—C═O bonds can be, for example, no less than about 1%, e.g., no less than about 1.2%, no less than about 1.4%, no less than about 1.6%, no less than about 1.8%, no less than about 2%, no less than about 2.2%, no less than about 2.4%, no less than about 2.6%, or no less than about 2.8%. Higher relative amounts, e.g., no less than about 3%, and lower relative amounts, e.g., no more than about 1%, are also contemplated.

In some embodiments, the graphene of the provided FGEN coating includes a total relative amount (e.g., as determined with an XPS C 1s spectra) of C—O bonds (e.g., bonds of hydroxyl moieties) that is between about 12.2% and about 12.8%; a total relative amount of C═O bonds (e.g., bonds of ketone moieties) and/or O—C—O bonds (e.g., bonds of epoxide moieties) that is between about 2.6% and about 3.4%; and a total relative amount of O—C═O bonds (e.g., bonds of carboxylate moieties) that is between about 1.7% and about 1.9%.

Oxygen functional groups can act as charge donors, chelating agents, and coordination complexes, which could potentially prevent the disproportionation of M³⁺ or trap M²⁺ ions as well as other transition metals. For example, oxygen containing groups in the functionalized graphene can exchange electrons with the manganese of the cathode active materials, thereby slowing or inhibiting the disproportionation reaction of the manganese. Additionally, manganese is well-known to bond strongly with oxygen containing groups in graphene oxide. Oxygen functional groups of the graphene in the provided FGEN coatings can capture manganese through either covalent bonding or non-covalent interactions. In some examples, manganese ions form coordination complexes with the four oxygen atoms of two carboxylic acid moieties located on adjacent graphene edges. In other examples, manganese ions form coordination complexes with two, three, or four oxygen atoms of two, three, or four hydroxyl, epoxide, and/or ketone moieties that are located on the same or separate graphene layers.

Similarly, graphene and oxygen containing functional groups in the coating could interact with HF created in the electrolyte.

The oxygen groups can be formed as the result of residual air in the PECVD system, and the relative amount of oxygen, or other dopants such as nitrogen or fluorine, could intentionally be increased or added to improve the efficacy of the coating if it is determined that the functional group is the critical variable in suppressing TMD. Exemplary nitrogen functionalization of the graphene in the provided FGEN coatings includes the formation of quaternary amine structures, pyridine structures, pyrrole structures, or combinations thereof (FIG. 4O).

Graphene defects are believed to trap Mn ions while allowing Li ions to pass through. Thus, although dry coatings do not necessarily provide an impenetrable physical coating, if the spacing of the FGEN coating particles is within the diffusion length of the TM ions, the TM ions could effectively be trapped. Additionally or alternatively, the functionalization of the graphene of the FGEN coating during growth can be configured such that the spacing of the functional groups is within the diffusion length of the TM ions. This density level of functional groups can better enable the functional groups to form covalent bonds or noncovalent interactions with the TM ions, thereby preventing their dissolution from the cathode active materials.

In some embodiments the average distance between adjacent pairs of functional groups on the surface of the graphene of the provided FGEN coating is between about 0.1 nm and about 100 nm, e.g., between about 0.1 nm and about 25 nm, between about 0.1 nm and about 6.3 nm, between about 0.1 nm and about 1.6 nm, between about 0.1 nm and about 0.4 nm, between about 0.4 nm and about 100 nm, between about 0.4 nm and about 25 nm, between about 0.4 nm and about 6.3 nm, between about 0.4 nm and about 1.6 nm, between about 1.6 nm and about 100 nm, between about 1.6 nm and about 25 nm, between about 1.6 nm and about 6.3 nm, between about 6.3 nm and about 100 nm, between about 6.3 nm and about 25 nm, or between about 25 nm and about 100 nm. In terms of upper limits, the average distance between adjacent pairs of functional groups can be, for example, no more than about 100 nm, e.g., no more than about 50 nm, no more than about 25 nm, no more than about 13 nm, no more than about 6.3 nm, no more than about 3.2 nm, no more than about 1.6 nm, no more than about 0.8 nm, no more than about 0.4 nm, or no more than about 0.2 nm. In terms of lower limits, the average distance between adjacent pairs of functional groups can be, for example, no less than about 0.1 nm, e.g., no less than about 0.2 nm, no less than about 0.4 nm, no less than about 0.8 nm, no less than about 1.6nm, no less than about 3.2 nm, no less than about 6.3 nm, no less than about 13 nm, no less than about 25 nm, or no less than about 50 nm. Larger distances, e.g., no less than about 100 nm, and shorter distances, e.g., no more than about 0.1 nm, are also contemplated.

TEM and Raman mapping provide complementary evidence to support this growth mechanism. Given the stochastic nature of the FBR it is reasonable to assume that within the pristine FGEN there are different stages of growth present. For example, we would expect to have a mixture of carbon coated silica particles with and without extended graphene sheets.

FIG. 4B is a transmission electron microscope image of nanoparticles. In this image, which has a scale of 50 nm, the nanoparticle SiO₂ is illustrated prior to the PECVD growth process.

FIG. 4C is a transmission electron microscope image of nanoparticles coated with nanocarbon according to an embodiment of the present invention. In this image, which also has a scale of 50 nm, the nanoparticles are coated with nanocarbon. Thus, this image shows a region of nanoparticles on which carbon is deposited, but extended, functionalized graphene sheets have not yet formed. Referring to FIGS. 4B and 4C, the average diameter of the pristine SiO₂ nanoparticles shown in FIG. 4B is 21 nm and that of the carbon coated particles shown in FIG. 4C is 37 nm, which corresponds to a layer thickness for the NC of 8 nm.

Thus, FIG. 4C shows layered structures on the order of 10 nm. The curvature of these structures suggests that they are associated with a nanoparticle coating. The thickness of this coating is consistent with the average measured thickness of the NC, i.e., 8 nm, and the layer spacing is consistent with graphite.

FIG. 4D is a transmission electron microscope image of layered graphene deposited on nanoparticles according to an embodiment of the present invention. In this high resolution image, which has a scale of 10 nm, the presence of layered graphene structures, including multiple layers of layered graphene, is shown. These layered graphene structures correspond to the one or more layers of NC 420 illustrated in FIG. 4A.

FIG. 4E is a transmission electron microscope image of nanoparticles coated with nanocarbon and extended, functionalized graphene according to an embodiment of the present invention. In this image, which also has a scale of 50 nm, the extended, functionalized graphene is coated on the nanocarbon coating the nanoparticles. This image shows an agglomeration of FGEN highlighting both the extended graphene sheets and the coated nanoparticles.

FIG. 4F is a plot of two representative component Raman spectra for extended, functionalized graphene coated nanoparticles according to an embodiment of the present invention. Raman spectroscopy is considered the “gold standard” for identifying graphene and other allotropes of carbon. RMCA of the FGEN produced two representative component spectra, which are shown in FIG. 4F.

The top spectrum 450 has only weak features at 1339 and 1576 cm⁻¹, which are characteristic of the D and G peaks of graphene, respectively, indicating that it is carbon (i.e., nanocarbon), but not necessarily graphene. These D and G peaks are distinct and do not overlap, suggesting that the carbon is not amorphous. Thus, this layer is ascribed as NC. The bottom spectrum 452 has features at 1339, 1576, and 2672 cm⁻¹, which are characteristic of the D, G, and 2D peaks of graphene, respectively. The D/G, 2D/G ratios, and the slight shoulder on the G peak is consistent with multilayer, vertical PECVD graphene.

Comparing the TEM images shown in FIGS. 4B-4E with the RMCA plot shown in FIG. 4G, the extended carbon sheets shown in FIG. 4E are ascribed to XG and the carbon coating on the silica particles is ascribed to NC shown in FIG. 4C. Furthermore we associate the NC layer with the PECVD basal layer. Although the Raman spectrum of the NC component is not strictly that of graphite, the basal layer is constrained by the underlying nanoparticle, and surface constraints may affect local density of states. Also, it is known that there are changes in the Raman spectrum of graphite at nanometer crystallite scale.

FIG. 4G is a plot showing an X-ray diffraction (XRD) analysis of silicon oxide nanoparticles and functionalized graphene encapsulated nanoparticles according to an embodiment of the present invention. In these XRD (Cu Kα) scans of the FGEN, upper trace 460 in FIG. 4G shows a small shift toward larger spacing of the FGEN peak (position noted by the arrow) indicating a 3.41 Å spacing in comparison to the 3.348 Å spacing expected from graphite. This slightly larger lattice spacing of the FGEN is consistent with the high magnification image of the graphene layers shown in FIG. 4D, which is somewhat less coherent than might be expected from a c-axis projection of graphite. XRD scans of pristine nanoparticle SiO₂ are provided as trace 462 for comparison.

FIG. 4H is an X-ray photoelectron spectroscopy (XPS) spectrum for functionalized graphene encapsulated nanoparticles according to an embodiment of the present invention. XPS was used to examine the elemental composition and the chemical and electronic states of the FGEN. The primary elemental components present in the survey spectra, not shown, were Si, O, and C, along with a trace amount of N. The atmospheric percentage (at %) of these elements was determined by the relative areas of the Si 2p, O 1s, and C 1s features. The average at % of Si, O, and C were 18.9±0.3, 46.0±1.5, and 34.7±1.9%, respectively. Trace amounts of Na and F were also observed, and these are associated with impurities in the SiO₂ nanoparticles and with the vacuum pump oil used in the PECVD system, respectively.

High resolution XPS spectra of pristine FGEN are shown in FIG. 4H. The representative C 1s region was fit following the procedure of Gengenbach et al., starting with a fit to graphite and then adding functional components based on the elements in the survey spectra; the binding energy (BE) and FWHM of the components were constrained based on literature values. The relative concentrations of the components were averaged from three areas. There are four peaks associated with graphene, (51.1±6.1%). The asymmetric peak at 284.2 eV corresponding to spectrum 470 is the main C1s feature, and the remaining three peaks at 287.7, 291.0, and 294.2 eV are associated with shake-up peaks. The component at 285.0 eV corresponding to spectrum 474 is associated with both C—C and C—H (29.9±6.9%). The component at 286.3 eV corresponding to spectrum 476 is associated with both C—O and C—N (12.5±0.3%). The component at 287.9 eV corresponding to spectrum 478 is associated with both C═O and O—C—O (3.0±0.4%). The component at 289.3 eV is associated with O—C═O (1.8±0.1%). The amount of nitrogen present in the survey spectra was negligible, and we can assume the same for C—N bonds. There is no evidence of SiC, 282 eV. The total relative amount of oxygen containing bonds in the C 1s spectra is 17%. The sp2/sp3 ratio was determined by analysis of the C (KLL) Auger peak in the survey spectra using the D-value method. The average % sp2 from four survey scans is 60±10%, (D-value=19.3±0.9), which is in the range of hydrogenated carbons. For comparison, the D-value of highly oriented pyrolytic graphene (HOPG) corresponding to spectrum 472, which is 100% sp2, is 22.5. The average percentage of graphene (51.1%±6%), which is % sp2 bonded, and the measured percentage of sp2 carbon 60±10%, are within acceptable agreement.

FIG. 4I is an XPS spectrum for the Si 2p region of functionalized graphene encapsulated nanoparticles according to an embodiment of the present invention. The Si 2p region extends from 101 to 108 eV and is centered at 104.9 eV. There is no evidence of elemental Si, 100.5 eV. The region is ascribed to nanoparticle silica.

FIG. 4J is an XPS spectrum for the O 1s region of functionalized graphene encapsulated nanoparticles according to an embodiment of the present invention. The O 1s region is centered at 534.0 eV and extends from 531 to 528 eV. An accurate fitting of the region is challenging because of the contributions from the C—O functional groups in the carbon and the underlying SiO₂. It is noted that the BE for O 1s SiOₓ (0<x<2) is lower than 532.8 eV.

Taken together, the C 1s, Si 2P, and O 1s features shown in FIGS. 4H, 4I, and 4J, respectively, indicate that silica nanoparticles have not been reduced or have formed SiC during the PECVD process. The ratio of Si:O taken from the survey scan is 1.0:2.4 compared to 1.0:2.0 for stoichiometric SiO₂. An excess in oxygen in the graphene is consistent with the analysis of the C 1s region. Oxygen groups in the FGEN are presumably the result of reactive plasma species formed concurrently during growth from residual air present in the PECVD system.

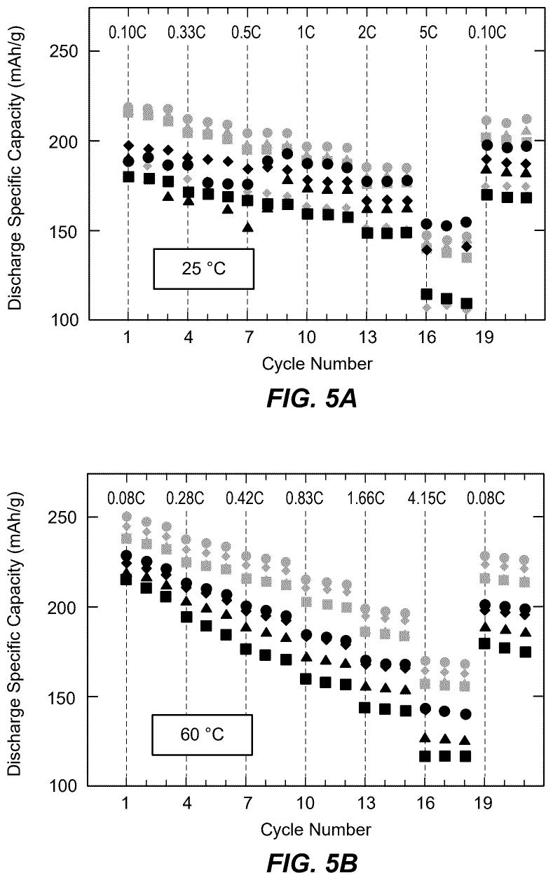

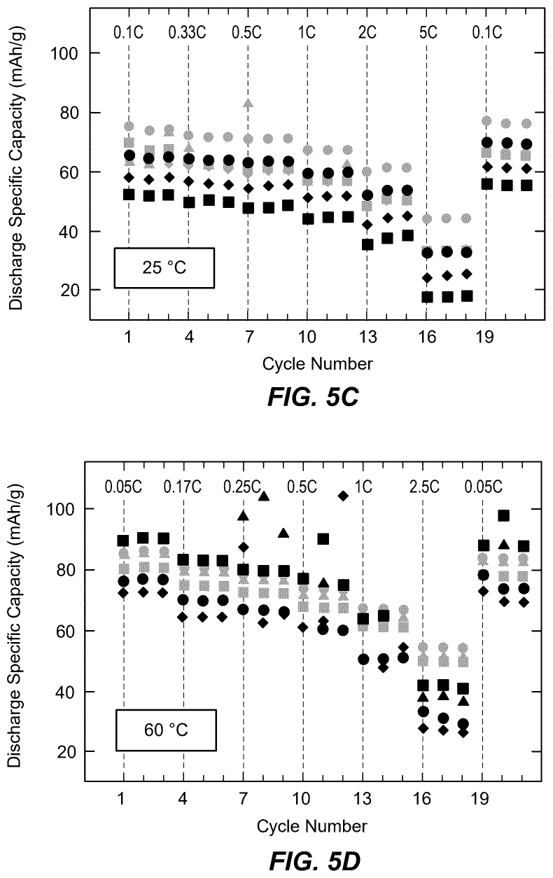

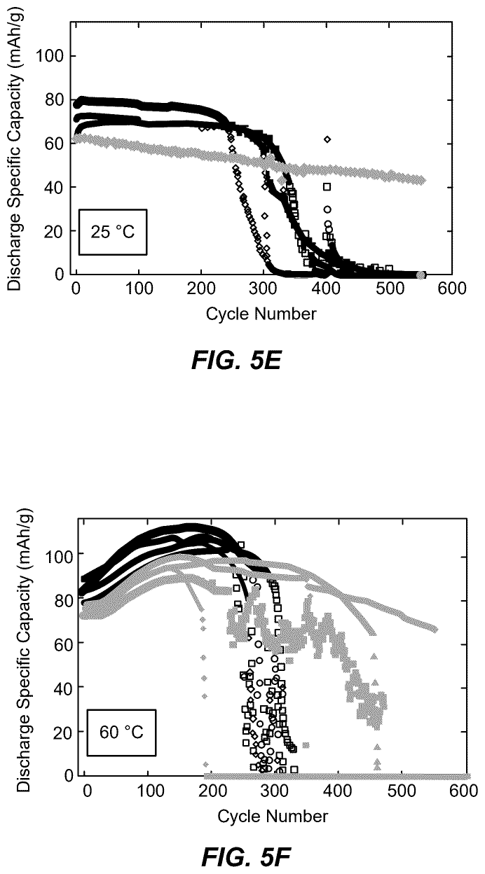

FIGS. 5A-5B are plots showing the discharge specific capacities of NMC811 CAM and NMC811 CAM coated with FGEN at 25° C. and 60° C., respectively. These plots demonstrate the comparative effects of FGEN coatings on the rate capability of NMC811 at 25° Cand 60° C. Four NMC811 and four NMC11-FGEN cells were cycled simultaneously. Each cell was charged and discharged for three cycles in a stepped progression of charge rates, C/10, C/3, C/2, 1 C, 2 C, and 5 C (1 C=180 mA/g). The averages for each step are summarized in Table 1.

TABLE 1
NMC811 Summary of rate capabilities (mAhr/g) at 25 and 60° C.

| | 25° C. | | | 60° C. | |
|---|---|---|---|---|---|
| Rate | Control | Graphene | Rate | Control | Graphene |
| C/10 | 182.7 ± 3.8 | 193.3 ± 4.8 | 0.08 C | 218.5 ± 1.9 | 240.4 ± 1.7 |
| C/3 | 175.8 ± 3.3 | 186.6 ± 4.6 | 0.28 C | 201.6 ± 2.6 | 228.1 ± 1.7 |
| C/2 | 170.7 ± 3.0 | 182.4 ± 4.3 | 0.42 C | 188.1 ± 3.0 | 219.5 ± 1.7 |
| C | 161.1 ± 2.9 | 170.8 ± 4.5 | 0.83 C | 173.1 ± 3.1 | 206.7 ± 1.8 |
| 2 C | 147.8 ± 3.3 | 151.4 ± 4.9 | 1.67 C | 158.0 ± 3.1 | 190.5 ± 1.7 |
| 5 C | 116.5 ± 4.5 | 110.3 ± 7.2 | 4.15 C | 131.2 ± 3.2 | 161.6 ± 1.6 |

At 25° C., there are slight increases in the rate capabilities of FGEN cells at C/10, C/3, C/2, and 1 C, of 6, 6, 7, and 6% respectively, and no significant differences between the control and FGEN cells at 2 C and 5 C. However at 60° C., the differences are significant. The NMC811-FGEN cells exhibit higher rate capabilities at all discharge rates. At C/10, C/3, C/2, C, 2 C, and 5 C at the relative differences are 10, 13, 17, 19, 21, and 23%, respectively. The cycling performances of the NMC811 half-cells from 3.0 to 4.3 V at 25 and 60° C. show that at 25° C., both the coated and uncoated groups of cells suffered severe capacity loss before 80 cycles, and at 60° C., similar behavior was observed even before 20 cycles. ICP-MS measurements were performed on a pair of these NMC811 cells and no evidence of TMD was found in either the NCM811 or NMC811-FGEN cells.

FIGS. 5C-5D are plots showing the discharge specific capacities of LNMC CAM and LNMC CAM coated with FGEN at 25° C. and 60° C., respectively. These plots show the comparative effects of FGEN coatings on rate capability and cycling performance of LNMC. There were three LNMC cells and four LNMC-FGEN cells. Each cell was charged and discharged for three cycles in a stepped progression of increasing discharge rates, C/10, C/3, C/2, C, 2 C, and 5 C, (1 C=150 mA/g, 3 to 4.3 V). The graphene cells exhibited, on average, higher specific discharge capacities at all discharge rates. At C/10, C/3, C/2, 1 C, 2 C, and 5 C the relative differences are 16, 15, 17, 15, 17, and 42% respectively. These rate capability results are summarized in Table 2.

TABLE 2
LNMC Summary of rate capability (mAhr/g) at 25° C.

25° C.

| Rate | Control | Graphene |
|---|---|---|
| C/10 | 58.3 ± 1.8 | 67.9 ± 1.5 |
| C/3 | 56.7 ± 2.0 | 65.0 ± 1.3 |
| C/2 | 55.5 ± 2.2 | 65.2 ± 2.1 |
| C | 51.9 ± 2.1 | 59.6 ± 1.4 |
| 2 C | 44.9 ± 2.3 | 52.7 ± 1.5 |
| 5 C | 25.5 ± 2.1 | 36.1 ± 1.4 |

FIGS. 5E-5F are plots showing the cycling performance of NMC811 CAM, LNMC CAM, NMC811 CAM coated with FGEN, and LNMC CAM coated with FGEN at 25° C. and 60° C., respectively. FIGS. 5E and 5F show the cycling performances at 1 C, 3 to 4.3 V. All graphene cells had similar capacity values and their cycle life curves overlay each other. The cell lifetimes with and without the FGEN coatings are remarkably different. The LNMC cells failed abruptly between 300 and 400 cycles, while both LNMC-FGEN cells cycled past 550 cycles. Similar behavior is observed at 60° C.

In FIGS. 5E and 5F, the control cells all fail around 300 cycles. The behavior differs for the LNMC-FGEN cells. One cell fails at 200 cycles; one cell began to exhibit erratic behavior at 250 cycles; and the other two cells cycled beyond 450 cycles. Data collected for FGEN mixed (1 wt %) using conventional mixing rather than dry coating indicated that these cells perform similarly to the control cells, indicating the effectiveness of the dry coating in improving the cell lifetimes. This also indicates that the increase in cell lifetimes is not solely due to the desiccative nature of the SiO₂ particles and that the combination of graphene and SiO₂ improves performance and dry coating.

The inventors performed a systematic study of TMD in LNMC over a range of upper cut-off voltages (UCV) of 4.30, 4.45, and 4.6 V. At each UCV, groups of four control cells and four cells with FGEN coatings were simultaneously cycled at 1 C (150 mA/g), 60° C. These cells underwent limited cycling, i.e. until all the cells had undergone at least 8 cycles and one of the cells in the entire group had lost at least 30% capacity. The inventors also performed a separate cycling study involving Electrochemical Impedance Spectroscopy (EIS) (potentiostatic). At each UCV, pairs of cells, one control cell and one FGEN cell, were simultaneously cycled while performing EIS every third cycle at 1 C, 60° C. These cells underwent extended cycling, i.e. they were cycled continuously until suffering dramatic losses in capacity. The pair of cells at each UCV were cycled for similar times. The lithium anodes from all of these cells were harvested and studied by ICP-MS.

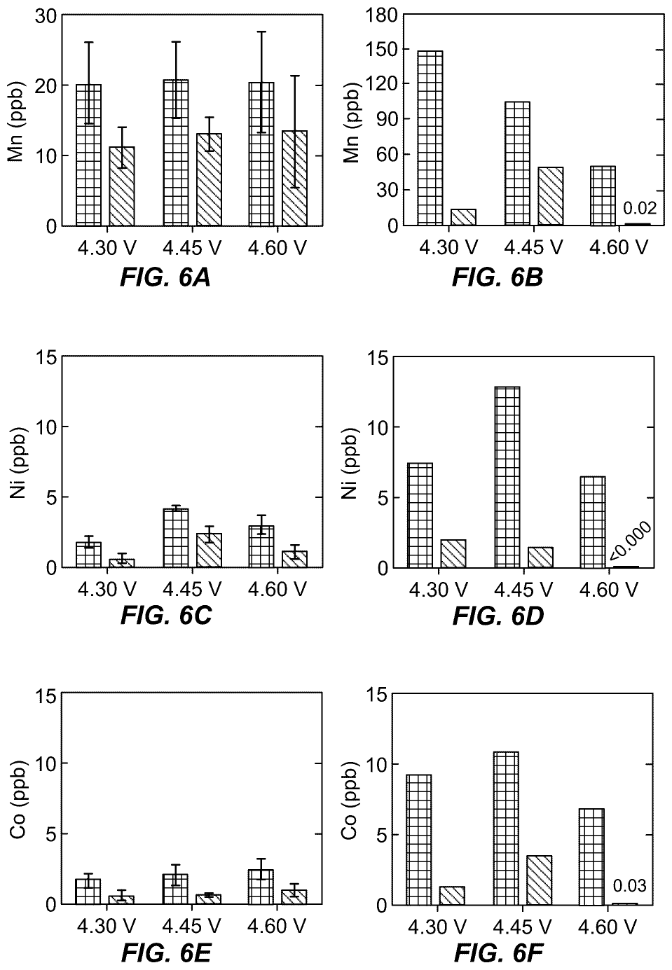

FIGS. 6A-6F are plots showing the concentrations of Mn, Ni, and Co in the lithium anodes of LNMC cells with and without FGEN coatings, respectively, after cycling according to an embodiment of the present invention. These figures provide comparisons of the concentrations (ppb) of Mn, Ni, and Co, found on the lithium anodes from LNMC half-cells with and without FGEN coatings after cycling. The cells were cycled at 1 C (1 C=150 mA/g), 60° C., and between 3.0 V and UCVs of 4.30, 4.45, and 4.60 V. The left column of panels (i.e., FIGS. 6A, 6C, and 6E) represents groups of eight cells that underwent limited cycling at a particular UCV and all were stopped when any one of the cells lost approximately 30% of its initial capacity. In each group, there were four cells with and four without FGEN coatings, and each bar represents the respective average. The right column of panels (i.e., FIGS. 6B, 6D, and 6F) represents individual cells that underwent extended cycling with EIS spectra taken every third cycle.

The concentrations of TM at all the UCV were significantly higher in the anodes of the uncoated cells than the coated cells for both limited and extended cycling. This clearly shows that the FGEN coatings are effectively suppressing TMD over a range of UCV. The TM concentration levels were higher for the cells that had undergone extensive cycling than limited cycling. For all the cells, Mn was the most prevalent transition metal of the three, followed by Ni and Co. For cells that had undergone limited cycling, the Mn was approximately 20 ppb on average for all the UCV and 12 ppb for the coated cell. For the cells that underwent extended cycling, the Mn concentration was highest in the 4.30 V charge cutoff and decreased with increasing UCV. At 4.6 V charge cutoff, the TMD levels in the coated cells were quite low <0.05 ppb. The cells that cycled at 4.30 V charge cutoff for extended cycles had the highest concentration of Mn. The cells cycled at 4.60 V charge cutoff suffered rapid capacity losses but the least amount of TMD.

Tables of the ICP-MS results are provided in Tables 3 and 4.

TABLE 3
Table of ICP-MS results (ppb) with UCV for limited cycling

| | 4.30 V | 4.45 V | 4.60 V |
|---|---|---|---|
| | (ppb) | (ppb) | (ppb) |
| Mn | | | |
| Control | 20.16 ± 5.7 | 20.69 ± 5.3 | 20.41 ± 7.2 |
| Graphene | 11.17 ± 3.0 | 12.93 ± 2.3 | 13.31 ± 7.9 |
| Ni | | | |
| Control | 1.89 ± 0.44 | 4.25 ± 0.14 | 3.04 ± 0.67 |
| Graphene | 0.67 ± 0.33 | 2.37 ± 0.53 | 1.19 ± 0.46 |
| Co | | | |
| Control | 1.72 ± 0.45 | 2.08 ± 0.72 | 2.51 ± 0.68 |
| Graphene | 0.61 ± 0.33 | 0.70 ± 0.09 | 1.02 ± 0.45 |

TABLE 4
Table of ICP-MS results (ppb) with UCV for
extended cycling with EIS every third cycle

| | 4.30 V | 4.45 V | 4.30 V |
|---|---|---|---|
| | (ppb) | (ppb) | (ppb) |
| Mn | | | |
| Control | 147.72 | 104.47 | 50.53 |
| Graphene | 13.74 | 49.57 | 0.02 |
| Ni | | | |
| Control | 7.42 | 12.87 | 6.54 |
| Graphene | 1.97 | 1.44 | <0.000 |
| Co | | | |
| Control | 9.16 | 10.84 | 6.78 |
| Graphene | 1.26 | 3.41 | 0.03 |

Overall, there is lower resistance in the graphene cells indicating reduced charge transfer. Analysis of the Warburg tail region generally shows improved Li⁺ diffusivity for LNMC-FGEN.

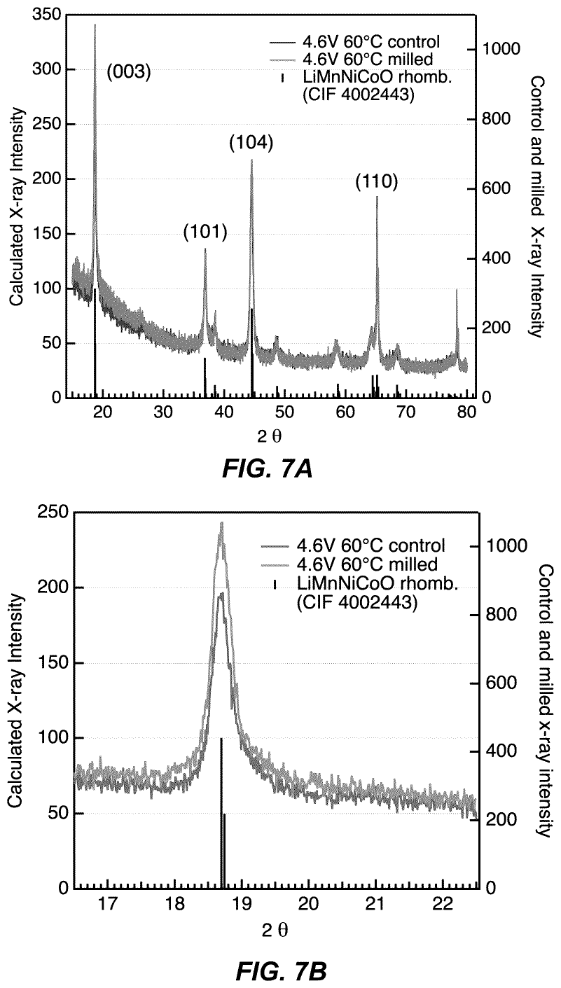

FIG. 7A is an X-ray photoelectron spectroscopy spectrum for LNMC and LNMC-FGEN cathodes that underwent extended cycling at 4.60 V charge cutoff, 60° C. according to an embodiment of the present invention.

FIG. 7B is a magnified region of the XRD spectrum shown in FIG. 7A according to an embodiment of the present invention. As shown in FIG. 7B, the XRD spectrum demonstrates the higher relative intensity of the (003) peak in the milled cathode when compared to the control. Of note is the greater intensity of planes in the direction of the c-axis of the milled cathode (both (003) and (104) planes) whereas (101) and (110) planes have intensities that are comparable in both the control and milled cathode, suggesting that the crystallographic structure of the cathode is better retained during cycling in the milled material.

Suppression of TMD during cycling by a dry coating as discussed herein is remarkable, especially at elevated temperatures and over a range of UCV. Dry-coated films do not necessarily form a continuous, physical barrier that could prevent TM ions from dissolving into the electrolyte and HF from directly contacting the CAM. However, the graphene in the FGEN coatings does contain functional groups and defects and as evidenced by Raman spectroscopy and XPS, and the inventors believe that these play a role in suppressing TMD. Oxygen functional groups can act as charge donors, chelating agents, and coordination complexes, which could potentially prevent the disproportionation of Mn³⁺ or trap Mn⁺ ions as well as other transition metals. For example, manganese is well-known to bond strongly with oxygen containing groups in graphene oxide. Similarly, graphene and oxygen containing functional groups in the coating could interact with HF created in the electrolyte. The oxygen groups, in some embodiments, are mainly the result of residual air in the PECVD system, and the relative amount of oxygen, or other dopants such as nitrogen or fluorine, could intentionally be increased or added to improve the efficacy of the coating if the functional group is the critical variable in suppressing TMD. Graphene defects are believed to trap Mn⁺ ions while allowing Li ions to pass through. Although dry coatings do not necessarily provide an impenetrable physical coating, if the spacing of the FGEN coating particles is within the diffusion length of the TM ions, the TM ions could effectively be trapped.

The inventors believe that it is unlikely that the FGEN coating alters transition metal mobility inside the cathode active material. Diffusion of transition metal ions through the bulk material to the surface depends on the transition metal concentration in the subsurface region—the diffusion is slower if the transition metal concentration is higher near the surface. It is not clear if the FGEN coatings have the greatest effect by maintaining the transition metal concentration just beneath the surface of cathode particles, through the cathode electrolyte interphase (CEI), or both. Nevertheless, a kinetic explanation of the effect of FGEN coatings on transition metal diffusion out of the active cathode particles seems more promising than a thermodynamic one. It is conceivable that the FGEN coating favorably reduces the concentration gradient of Mn in the cathode particles, and reduces the loss of Mn by TMD. The improved crystal quality should result in faster diffusion of the lithium ions during charge and discharge. This is supported by marked improvements in Li+ diffusivity with the LNMC-FGEN, as found by EIS. Similarly, measurements on cycled, uncoated LMO reveal an amorphous CEI and Mn depletion region on the order of tens of nanometers, which is an appreciable fraction of the average radius of the LNMC primary particles, 100 nm. Presumably, similar regions of Mn depletion would exist in the uncoated LNMC and would contribute to the reduction the Li+ diffusion.

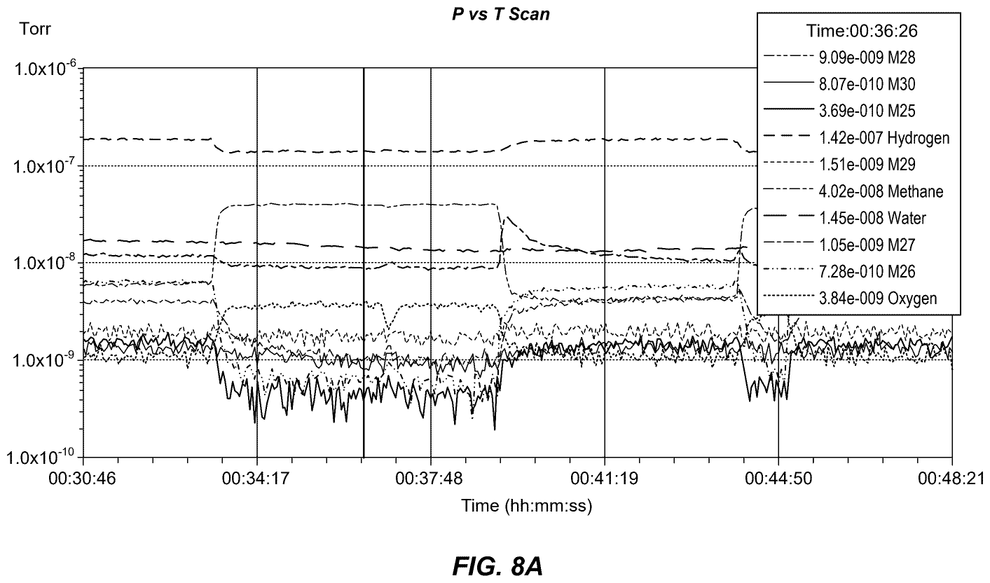

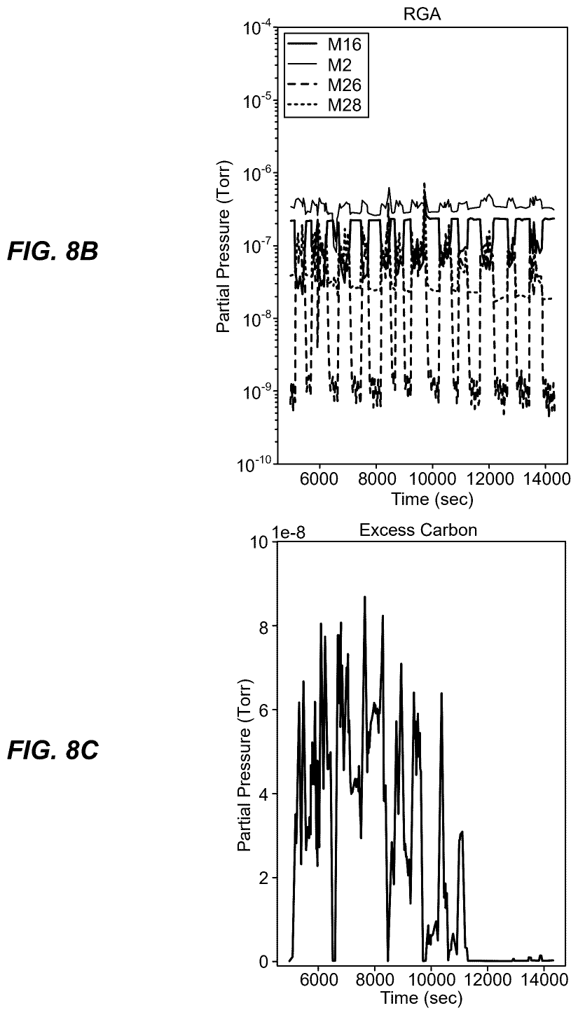

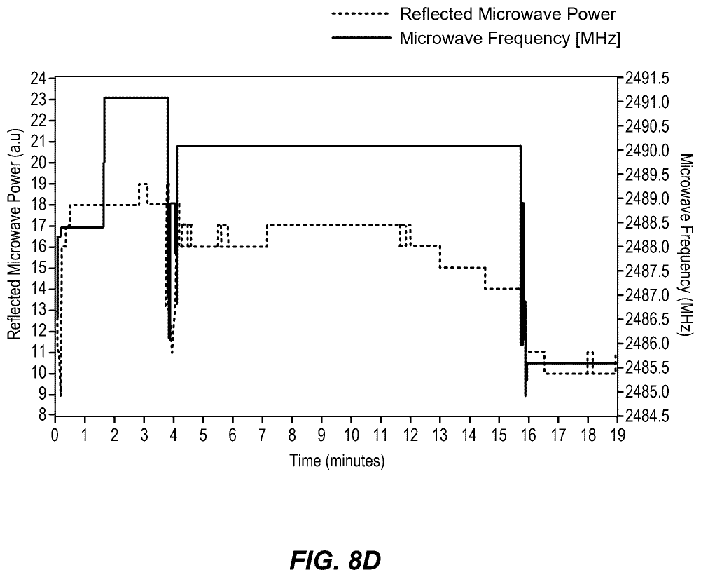

FIG. 8A is a plot showing partial gas pressures in the plasma enhanced chemical vapor deposition chamber during growth according to an embodiment of the present invention. As discussed in relation to FIG. 2, an RGA 240 (i.e., SRS RGA100) was placed downstream of the reactor 210 and was used to monitor the reactants and reaction products during growth. A typical RGA scan of partial pressures with time is shown in FIG. 8A. The primary reactants are H₂ and CH₄. Also present are atmospheric H₂O, O₂, and N₂ (M28). The listed partial pressures are provided with the plasma off.

During growth, methane, CH₄ (M16) is primarily decomposed by the plasma into acetylene, C₂H₂, ethane, C₂H₆, hydrogen, H₂, which are M26, M28, and M2, respectively, based on the cracking patterns for these molecule. It should be noted that M28 is also CO, which can be formed from residual oxygen present in the system.

FIG. 8B is a plot showing partial pressures of select reactants and products during growth according to an embodiment of the present invention. In this plot, a typical RGA scan of partial pressure with time during PECVD growth is shown. When the plasma is ignited, the methane partial pressure drops and correspondingly the partial pressures for acetylene and ethane, M26 and M28, respectively, increase. In the presence of the silica powder, the partial pressures for both the acetylene and ethane decrease while that of the hydrogen, M2, increases. This coincides with an eventual darkening of the silica indicating carbon deposition.

FIG. 8C is a plot of excess carbon as a function of growth time according to an embodiment of the present invention. The amount of carbon deposited, C_{excess}, can be estimated by the stoichiometric relation:

$$Δ {CH}_{4} \to α {C}_{2} {H}_{2} + β {C}_{2} {H}_{6} + {ξΔH}_{2} + {C}_{e x c e s s}$$

$$α + β = \frac{1}{2}$$

$$ξ = 2 α + \frac{1}{2} .$$

In these equations, ΔCH₄ and ΔH₂ are the measured changes in methane and hydrogen partial pressures, and α, β, and ξ are the stoichiometric coefficients. Relative constants determined from measured relative partial pressures are

$$α = \frac{5}{8} β .$$

FIG. 8D is a plot of reflected microwave power and microwave frequency during growth according to an embodiment of the present invention. The reflected microwave power is plotted on the left ordinate axis and the microwave frequency is plotted on the right ordinate axis. Both values are plotted as a function of time during PECVD growth.

Graphene is conductive and, as it forms, it can reflect the microwave radiation that is incident on the growth chamber and the sample during growth. As a result, the reflected power and microwave frequency will change during growth. Based on the data illustrated in FIG. 8D, growth statistics and end point detection can be utilized. One of ordinary skill in the art would recognize many variations, modifications, and alternatives.

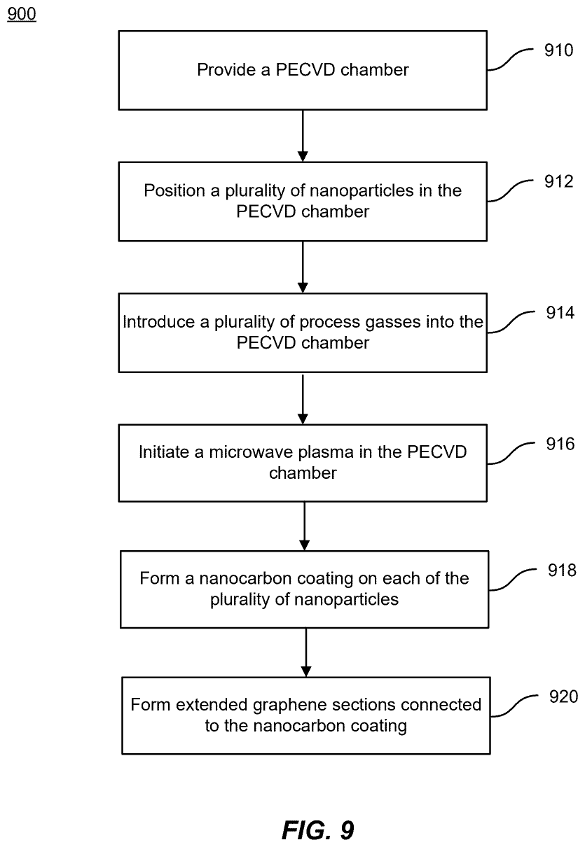

FIG. 9 is a simplified flowchart illustrating a method of fabricating functionalized graphene encapsulated nanoparticles according to an embodiment of the present invention. The method 900 includes providing a plasma enhanced chemical vapor deposition (PECVD) chamber (910), positioning a plurality of nanoparticles in the PECVD chamber (912), introducing a plurality of process gasses into the PECVD chamber (914), and initiating a microwave plasma in the PECVD chamber (916). The PECVD chamber can be a fluidized bed reactor. The plurality of process gasses can include hydrogen, methane, oxygen, and/or nitrogen.

The method also includes forming a nanocarbon coating on each of the plurality of nanoparticles (918) and forming extended graphene sections connected to the nanocarbon coating, wherein the nanocarbon coating or the extended graphene sections include functional groups comprising hydrogen, oxygen, or nitrogen (920).

In some embodiments, the method further includes providing a plurality of cathode active material units, performing dry milling using the plurality of cathode active material units and the functionalized graphene encapsulated nanoparticles, and at least partially encapsulating each of the plurality of cathode active material units using the functionalized graphene encapsulated nanoparticles. Moreover, the method can also include assembling a cathode including the plurality of cathode active material units partially encapsulated in the functionalized graphene encapsulated nanoparticles and the binder. The functionalized graphene encapsulated nanoparticles can be present at approximately 1% by weight during dry milling.

The extended graphene sections can include two-dimensional graphene sheets and in some embodiments, the extended graphene sections consist of two-dimensional graphene sheets. In some embodiments, the method can further include fully encapsulating each of the plurality of cathode active material units using the functionalized graphene encapsulated nanoparticles. The nanocarbon coating and the extended graphene sections can include functional groups comprising hydrogen, oxygen, or nitrogen. In a particular embodiment, the method also includes measuring an acetylene partial pressure in the PECVD chamber, measuring an ethane partial pressure in the PECVD chamber, measuring a methane partial pressure in the PECVD chamber, determining a change in the partial pressure of methane in the PECVD chamber, measuring a hydrogen partial pressure in the PECVD chamber, determining a change in the partial pressure of hydrogen in the PECVD chamber, computing an amount of excess carbon based on the acetylene partial pressure, the ethane partial pressure, the change in the partial pressure of methane, and the change in the partial pressure of hydrogen, and terminating the method.

It should be appreciated that the specific steps illustrated in FIG. 9 provide a particular method of fabricating functionalized graphene encapsulated nanoparticles according to an embodiment of the present invention. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a battery cell comprising: an electrolyte; an anode; and a cathode, wherein the cathode comprises a plurality of cathode active material units at least partially coated with graphene encapsulated nanoparticles, carbon, and binders, wherein each of the graphene encapsulated nanoparticles comprises a nanoparticle encapsulated in one or more graphene layers, an outermost of the one or more graphene layers having extended graphene sections, wherein the one or more graphene layers or the extended graphene sections comprise one or more functional groups including hydrogen, oxygen, or nitrogen.

Example 2 is the battery cell of example 1 wherein the plurality of cathode active material units comprises LiNi_{0.8}Mn_{0.1}Co_{0.1}O₂ (NMC811) or Li_{1.2}Ni_{0.13}Mn_{0.54}Co_{0.13}O₂ (LNMC).

Example 3 is the battery cell of example(s) 1-2 wherein the nanoparticle comprises silica.

Example 4 is the battery cell of example(s) 1-3 wherein the one or more functional groups comprise carbon-hydrogen functional groups.

Example 5 is the battery cell of example(s) 1-4 wherein the one or more functional groups comprise carbon-oxygen functional groups.

Example 6 is the battery cell of example(s) 1-5 wherein the one or more graphene layers or the extended graphene sections comprise a total relative amount of oxygen-containing bonds that is between about 10% and about 30%.

Example 7 is the battery cell of example(s) 1-6 wherein at least a portion of the carbon-oxygen functional groups comprise C—O bonds.

Example 8 is the battery cell of example(s) 1-7 wherein at least a portion of the carbon-oxygen functional groups comprise epoxide moieties.

Example 9 is the battery cell of example(s) 1-8 wherein the one or more graphene layers or the extended graphene sections comprise a total relative amount of C—O bonds that is between about 8% and about 20%.

Example 10 is the battery cell of example(s) 1-9 wherein at least a portion of the carbon-oxygen functional groups comprise C═O bonds, O—C—O bonds, or a combination thereof.

Example 11 is the battery cell of example(s) 1-10 wherein at least a portion of the carbon-oxygen functional groups comprise ketone moieties, epoxide moieties, or a combination thereof.

Example 12 is the battery cell of example(s) 1-11 wherein the one or more graphene layers or the extended graphene sections comprise a total relative amount of C═O bonds and O—C—O bonds that is between about 2% and about 5%.

Example 13 is the battery cell of example(s) 1-12 wherein at least a portion of the carbon-oxygen functional groups comprise O—C═O bonds.

Example 14 is the battery cell of example(s) 1-13 wherein at least a portion of the carbon-oxygen functional groups comprise carboxylic acid moieties.

Example 15 is the battery cell of example(s) 1-14 wherein the one or more graphene layers or the extended graphene sections comprise a total relative amount of O—C═O bonds that is between about 1% and about 3%.

Example 16 is the battery cell of example(s) 1-15 wherein the one or more graphene layers or the extended graphene sections comprise: a total relative amount of C—O bonds that is between about 8% and about 20%; a total relative amount of C═O bonds and O—C—O bonds that is between about 2% and about 5%; and; a total relative amount of O—C═O bonds that is between about 1% and about 3%.

Example 17 is the battery cell of example(s) 1-16 wherein the one or more functional groups comprise carbon-nitrogen functional groups.

Example 18 is the battery cell of example(s) 1-17 wherein the average distance between adjacent functional groups of the one or more functional groups is less than a diffusion length of a transmission metal ion of the plurality of cathode active material units.

Example 19 is the battery cell of example(s) 1-18 wherein the average distance between adjacent functional groups of the one or more functional groups is no more than about 100 nm.

Example 20 is the battery cell of example(s) 1-19 wherein the plurality of cathode active material units are fully coated with the functionalized graphene encapsulated nanoparticles.

Example 21 is the battery cell of example(s) 1-20 wherein the one or more graphene layers and the extended graphene sections comprise one or more functional groups including hydrogen, oxygen, or nitrogen.

Example 22 is a cathode material comprising: a plurality of cathode active material units; graphene encapsulated nanoparticles joined to each of the plurality of cathode active material units, wherein each of the graphene encapsulated nanoparticles includes: a nanoparticle; one or more graphene layers encapsulating the nanoparticle; and extended graphene sections spatially extending from the one or more graphene layers, wherein the one or more graphene layers or the extended graphene sections comprise one or more functional groups including hydrogen, oxygen, or nitrogen.

Example 23 is the cathode material of example 22 wherein the graphene encapsulated nanoparticles at least partially surround each of the plurality of cathode active material units.

Example 24 is the cathode material of example(s) 22-23 wherein the graphene encapsulated nanoparticles fully surround each of the plurality of cathode active material units.

Example 25 is the cathode material of example(s) 22-24 wherein the one or more functional groups include hydrogen, oxygen, and nitrogen.

Example 26 is the cathode material of example(s) 22-25 wherein the one or more graphene layers and the extended graphene sections comprise one or more functional groups including hydrogen, oxygen, or nitrogen.

Example 27 is the cathode material of example(s) 22-26 wherein the plurality of cathode active material units comprises LiNi_{0.8}Mn_{0.1}Co_{0.1}O₂ (NMC811) or Li_{1.2}Ni_{0.13}Mn_{0.54}Co_{0.13}O₂ (LNMC).

Example 28 is the cathode material of example(s) 22-27 wherein the nanoparticle comprises silica.

Example 29 is the cathode material of example(s) 22-28 wherein the nanoparticle comprises metal phosphate, carbon, fluorides, oxide, metal oxide.

Example 30 is the cathode material of example(s) 22-29 wherein the nanoparticle comprises aluminum fluoride, aluminum phosphate, or aluminum oxide.

Example 31 is the cathode material of example(s) 22-30 wherein the one or more functional groups comprise carbon-hydrogen functional groups.

Example 32 is the cathode material of example(s) 22-31 wherein the one or more functional groups comprise carbon-oxygen functional groups.

Example 33 is the cathode material of example(s) 22-32 wherein the carbon-oxygen functional groups comprises oxygen double bond species.

Example 34 is the cathode material of example(s) 22-33 wherein the one or more functional groups comprise carbon-nitrogen functional groups.

Example 35 is the cathode material of example(s) 22-34 wherein the plurality of cathode active material units are fully coated with the functionalized graphene encapsulated nanoparticles.

Example 36 is the cathode material of example(s) 22-35 wherein the one or more graphene layers and the extended graphene sections comprise one or more functional groups including hydrogen, oxygen, and nitrogen.

Example 37 is the cathode material of example(s) 22-36 wherein the one or more graphene layers and the extended graphene sections comprise one or more functional groups including fluorine, phosphorus, boron, iodine, or sulfur.

Example 38 is a method of fabricating functionalized graphene encapsulated nanoparticles, the method comprising: providing a plasma enhanced chemical vapor deposition (PECVD) chamber; positioning a plurality of nanoparticles in the PECVD chamber; introducing a plurality of process gasses into the PECVD chamber; initiating a microwave plasma in the PECVD chamber; forming a nanocarbon coating on each of the plurality of nanoparticles; and forming extended graphene sections connected to the nanocarbon coating, wherein the nanocarbon coating or the extended graphene sections include functional groups comprising hydrogen, oxygen, or nitrogen.

Example 39 is the method of example 38 further comprising: providing a plurality of cathode active material units; performing dry milling using the plurality of cathode active material units and the functionalized graphene encapsulated nanoparticles; and at least partially encapsulating each of the plurality of cathode active material units using the functionalized graphene encapsulated nanoparticles.

Example 40 is the method of example(s) 38-39 further comprising assembling a cathode including the plurality of cathode active material units partially encapsulated in the functionalized graphene encapsulated nanoparticles and a binder.

Example 41 is the method of example(s) 38-40 further comprising fully encapsulating each of the plurality of cathode active material units using the functionalized graphene encapsulated nanoparticles.

Example 42 is the method of example(s) 38-41 wherein the functionalized graphene encapsulated nanoparticles are present at approximately 1% by weight during dry milling.

Example 43 is the method of example(s) 38-42 wherein the PECVD chamber comprises a fluidized bed reactor.

Example 44 is the method of example(s) 38-43 wherein the plurality of process gasses comprise hydrogen, methane, oxygen, and nitrogen.

Example 44 is the method of example(s) 38-44 wherein the plurality of process gasses comprise hydrogen, methane, oxygen, or nitrogen.

Example 46 is the method of example(s) 38-45 wherein the extended graphene sections comprise two-dimensional graphene sheets.

Example 47 is the method of example(s) 38-46 wherein the extended graphene sections consist of two-dimensional graphene sheets.

Example 48 is the method of example(s) 38-47 wherein the nanocarbon coating and the extended graphene sections include functional groups comprising hydrogen, oxygen, or nitrogen.

Example 49 is the method of example(s) 38-48 further comprising: measuring an acetylene partial pressure in the PECVD chamber; measuring an ethane partial pressure in the PECVD chamber; measuring a methane partial pressure in the PECVD chamber; determining a change in the partial pressure of methane in the PECVD chamber; measuring a hydrogen partial pressure in the PECVD chamber; determining a change in the partial pressure of hydrogen in the PECVD chamber; computing an amount of excess carbon based on the acetylene partial pressure, the ethane partial pressure, the change in the partial pressure of methane, and the change in the partial pressure of hydrogen; and terminating the method.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A battery cell comprising:
an electrolyte;
an anode; and
a cathode, wherein the cathode comprises a plurality of cathode active material units at least partially coated with graphene encapsulated nanoparticles, carbon, and binders, wherein each of the graphene encapsulated nanoparticles comprises a nanoparticle encapsulated in one or more graphene layers, an outermost of the one or more graphene layers having extended graphene sections, wherein the one or more graphene layers or the extended graphene sections comprise one or more functional groups including hydrogen, oxygen, or nitrogen.

2. The battery cell of claim 1 wherein the plurality of cathode active material units comprises LiNi_{0.8}Mn_{0.1}Co_{0.1}O₂ (NMC811) or Li_{1.2}Ni_{0.13}Mn_{0.54}Co_{0.13}O₂ (LNMC).

3. The battery cell of claim 1 wherein the one or more functional groups comprise carbon-hydrogen functional groups.

4. The battery cell of claim 1 wherein the one or more functional groups comprise carbon-oxygen functional groups.

5. The battery cell of claim 4 wherein the one or more graphene layers or the extended graphene sections comprise a total relative amount of oxygen-containing bonds that is between about 10% and about 30%.

6. The battery cell of claim 4 wherein at least a portion of the carbon-oxygen functional groups comprise C—O bonds.

7. The battery cell of claim 4 wherein at least a portion of the carbon-oxygen functional groups comprise epoxide moieties.

8. The battery cell of claim 4 wherein the one or more graphene layers or the extended graphene sections comprise a total relative amount of C—O bonds that is between about 8% and about 20%.

9. The battery cell of claim 4 wherein at least a portion of the carbon-oxygen functional groups comprise C═O bonds, O—C—O bonds, or a combination thereof.

10. The battery cell of claim 4 wherein at least a portion of the carbon-oxygen functional groups comprise ketone moieties, epoxide moieties, or a combination thereof.

11. The battery cell of claim 9 wherein the one or more graphene layers or the extended graphene sections comprise a total relative amount of C═O bonds and O—C—O bonds that is between about 2% and about 5%.

12. The battery cell of claim 4 wherein at least a portion of the carbon-oxygen functional groups comprise O—C═O bonds.

13. The battery cell of claim 4 wherein at least a portion of the carbon-oxygen functional groups comprise carboxylic acid moieties.

14. The battery cell of claim 12 wherein the one or more graphene layers or the extended graphene sections comprise a total relative amount of O—C═O bonds that is between about 1% and about 3%.

15. The battery cell of claim 4 wherein the one or more graphene layers or the extended graphene sections comprise:
a total relative amount of C—O bonds that is between about 8% and about 20%;
a total relative amount of C═O bonds and O—C—O bonds that is between about 2% and about 5%; and
a total relative amount of O—C═O bonds that is between about 1% and about 3%.

16. The battery cell of claim 1 wherein the one or more functional groups comprise carbon-nitrogen functional groups.

17. The battery cell of claim 1 wherein the average distance between adjacent functional groups of the one or more functional groups is less than a diffusion length of a transmission metal ion of the plurality of cathode active material units.

18. The battery cell of claim 1 wherein the average distance between adjacent functional groups of the one or more functional groups is no more than about 100 nm.

19. The battery cell of claim 1 wherein the plurality of cathode active material units are fully coated with the functionalized graphene encapsulated nanoparticles.

20. The battery cell of claim 1 wherein the one or more graphene layers and the extended graphene sections comprise one or more functional groups including hydrogen, oxygen, or nitrogen.
